(19) United States
(12) Patent Application Publication
(10) Pub. No.: US 2016/0117824 A1
(43) Pub. Date: Apr. 28, 2016

(54) POSTURE ESTIMATION METHOD AND ROBOT

(71) Applicant: TOYOTA JIDOSHA KABUSHIKI KAISHA, Toyota-shi, Aichi (JP)

(72) Inventors: Ayako AMMA, Toyota-shi (JP); Hirohito HATTORI, Nagakute-shi (JP); Kunimatsu HASHIMOTO, Nagakute-shi (JP)

(73) Assignee: TOYOTA JIDOSHA KABUSHIKI KAISHA, Toyota-shi, Aichi (JP)

(21) Appl. No.: 14/894,843

(22) PCT Filed: Jul. 29, 2014
(86) PCT No.: PCT/JP2014/003976

§ 371 Date: Nov. 30, 2015

(30) Foreign Application Priority Data
Sep. 12, 2013 (JP) 2013-189660

(51) Int. Cl. G06T 7/00; G06K 9/32; H04N 13/02; G06T 7/20

(52) U.S. Cl. CPC G06T 7/0042; G06T 7/2086; G06K 9/3216; H04N 13/0203; G06K 2209/21; G06K 2009/3291; G06K 2009/3225; G06T 2207/30204; G06T 2207/30244

(57) ABSTRACT

An image recognition method according to one aspect of the present invention acquires a camera image generated by capturing a subject using a camera (three-dimensional sensor). A plurality of coordinates corresponding to a plurality of pixels included in a predetermined area in the camera image are acquired. Subject distance information indicating a distance from the subject to the camera in the plurality of pixels is acquired. Then the posture of the subject surface included in the subject in the predetermined area is estimated based on the plurality of coordinates and the plurality of pieces of subject distance information that have been acquired.

### TECHNICAL FIELD

The present invention relates to a posture estimation method and a robot.

### BACKGROUND ART

A robot that operates in accordance with an ambient environment has been proposed.

Such a robot recognizes various planes in an environment where the robot moves and executes various operations such as walking, holding an object, and placing an object.

For example, Patent Literature 1 discloses a plane estimation method using a stereo camera. First, a stereo image is picked up, and a plurality of feature points are extracted for a reference image in the stereo image. Three-dimensional coordinates are obtained using the principle of triangulation from the parallax obtained by searching a corresponding point in another image for each feature point that has been extracted. Then an image similar to the image at the position of each feature point that has been extracted is detected from images before and after the movement of the object, and a three-dimensional position of the plane is calculated from a three-dimensional motion vector of each feature point that has been extracted.

### CITATION LIST

### Patent Literature

[Patent literature] Japanese Unexamined Patent Application Publication No. 2006-105661

### SUMMARY OF INVENTION

### Technical Problem

In order to use the method disclosed in Patent Literature 1, the stereo camera needs to be used since information on the parallax of two images is needed. However, the stereo camera is more expensive than a monocular camera. It is therefore difficult to reduce the cost of a sensor (camera). Although a posture estimation method using only the monocular camera has been proposed, the estimation accuracy of the method is not sufficiently high.

The present invention has been made in order to solve the above problem and aims to provide a posture estimation method and a robot that can be prepared for a low cost and are capable of securing a high estimation accuracy.

### Solution to Problem

A posture estimation method according to an aspect of the present invention includes: acquiring a captured image generated by capturing a subject using an imaging apparatus; acquiring a plurality of coordinates corresponding to a plurality of pixels included in a predetermined area in the captured image; acquiring subject distance information indicating a distance from the subject to the imaging apparatus in the plurality of pixels; and estimating a posture of the subject surface included in the subject in the predetermined area based on the plurality of pieces of subject distance information and the plurality of coordinates that have been acquired. It is therefore possible to estimate the posture of the subject surface for a low cost without using the stereo camera. Further, since the posture of the subject surface is estimated using information of the subject distance in addition to the coordinate of the plane, it is possible to secure the high estimation accuracy.

Further, the above method may include: acquiring a distance image where each pixel includes the subject distance information; associating the pixels in the captured image with the pixels in the distance image; and acquiring the subject distance information from pixels corresponding to the plurality of pixels in the predetermined area of the pixels in the distance image.

Further, the above method may include: calculating three-dimensional coordinates of the plurality of pixels based on the subject distance information and coordinates of the plurality of pixels; and estimating the posture of the subject surface included in the predetermined area based on the three-dimensional coordinates of the plurality of pixels.

Further, the above method may include: attaching a marker to the subject surface; detecting a marker area including the marker in the captured image as the predetermined area; and estimating the posture of the marker included in the marker area that has been detected.

Further, the above method may include: calculating an equation of a projection plane that is parallel to the subject surface using the subject distance information and the coordinates of the plurality of pixels; projecting a feature point indicating the posture of the marker in the captured image onto the projection plane; and estimating the posture of the marker based on the coordinates of the feature point projected onto the projection plane.

Further, the above method may include specifying the coordinates of the feature point in the captured image with sub-pixel precision to project the feature point onto the projection plane using the coordinates of the feature point that have been specified.

Further, the above method may include: estimating the position of the marker based on the coordinates of the feature point projected onto the projection plane; calculating the coordinates of the feature point on the projection plane using information regarding the estimated posture of the marker, the estimated position of the marker, and the size of the marker that has been set in advance; projecting the feature point that has been calculated on the projection plane onto the captured image; comparing, in the captured image, the coordinates of the feature point when the subject is captured with the coordinates of the feature point that have been projected; and determining an estimation accuracy based on the comparison result.

Further, the above method may include: estimating the position of the marker based on the coordinates of the feature point projected onto the projection plane; calculating the coordinates of the feature point on the projection plane using information regarding the estimated posture of the marker, the estimated position of the marker, and the size of the marker that has been set in advance; comparing the coordinates of the feature point projected from the captured image when the posture of the marker is estimated with the coordinates of the feature point that have been calculated on the projection plane; and determining an estimation accuracy based on the comparison result.

Further, in the above method, the marker may have a substantially rectangular shape, the apices of the marker in the captured image may be detected as the feature points, when the number of feature points that have been detected is two or three, sides of the marker extending from the feature points that have been detected may be extended; and the intersection of the sides that have been extended may be estimated as the feature point.

Further, in the above method, the marker may have a substantially rectangular shape, the apices of the marker in the captured image may be detected as the feature points, when the number of feature points that have been detected is four or less, sides of the marker extending from the feature points that have been detected may be extended; and a point that is located on the sides that have been extended and is spaced apart from the feature points that have been detected by a predetermined distance may be estimated as the feature point.

A robot according to one aspect of the present invention includes: the imaging apparatus; a distance sensor that acquires the subject distance information; and a posture estimation device that executes the posture estimation method described above.

### Advantageous Effects of Invention

According to the present invention, it is possible to provide a posture estimation method and a robot that can be prepared for a low cost and are capable of securing a high estimation accuracy.

### BRIEF DESCRIPTION OF DRAWINGS

FIG. 1 is a block diagram of a posture estimation system according to a first embodiment;

FIG. 2 is a diagram showing one example of a camera image;

FIG. 3 is a diagram showing one example of a distance image;

FIG. 4 is a diagram for describing an association of pixels of the camera image and the distance image;

FIG. 5 is a diagram for describing an association of pixels of the camera image and the distance image;

FIG. 6 is a flowchart showing an operation of the posture estimation system according to the first embodiment;

FIG. 7 is a diagram for describing an operation for reading out a marker ID according to the first embodiment;

FIG. 8 is a diagram for describing an operation for cutting out a marker area according to the first embodiment;

FIG. 9 is a diagram for describing an operation for estimating a plane including a marker according to the first embodiment;

FIG. 10 is a diagram for describing an operation for estimating the position and the posture of the marker according to the first embodiment;

FIG. 11 is a block diagram of a posture estimation system according to a second embodiment;

FIG. 12 is a flowchart showing an operation of the posture estimation system according to the second embodiment;

FIG. 13 is a diagram for describing an operation for estimating the position and the posture of a marker according to the second embodiment;

FIG. 14 is a diagram for describing a method for evaluating an estimation accuracy according to the second embodiment;

FIG. 15 is a diagram for describing a method for evaluating the estimation accuracy according to the second embodiment;

FIG. 16 is a diagram showing one example of a camera image according to a modified example;

FIG. 17 is a diagram for describing an operation for cutting out a marker area according to the modified example;

FIG. 18 is a diagram for describing an operation for estimating a column including a marker according to the modified example;

FIG. 19 is a diagram for describing an operation for estimating the position and the posture of the marker according to the modified example;

FIG. 20 is a diagram for describing an operation for estimating the position and the posture of the marker according to the modified example;

FIG. 21 is a diagram showing a marker that is partially hidden according to a third embodiment;

FIG. 22 is a diagram for describing an operation for estimating a feature point that is hidden according to the third embodiment;

FIG. 23 is a diagram for describing an operation for estimating the position of a marker according to the third embodiment;

FIG. 24 is a diagram for describing an operation for estimating the posture of the marker according to the third embodiment;

FIG. 25 is a diagram showing a marker that is partially hidden according to the third embodiment;

FIG. 26 is a diagram for describing an operation for estimating feature points that are hidden according to the third embodiment;

FIG. 27 is a diagram for describing an operation for estimating the position of the marker according to the third embodiment;

FIG. 28 is a diagram for describing an operation for estimating the posture of the marker according to the third embodiment;

FIG. 29 is a diagram showing a marker that is partially hidden according to the third embodiment;

FIG. 30 is a diagram for describing an operation for estimating feature points that are hidden according to the third embodiment;

FIG. 31 is a diagram for describing an operation for estimating the position of the marker according to the third embodiment;

FIG. 32 is a diagram for describing an operation for estimating the posture of the marker according to the third embodiment;

FIG. 33 is a diagram showing a marker that is partially hidden according to the third embodiment;

FIG. 34 is a diagram for describing an operation for estimating feature points that are hidden according to the third embodiment;

FIG. 35 is a diagram for describing an operation for estimating the position of the marker according to the third embodiment; and

FIG. 36 is a diagram for describing an operation for estimating the posture of the marker according to the third embodiment.

### DESCRIPTION OF EMBODIMENTS

### First Embodiment

Hereinafter, with reference to the drawings, embodiments of the present invention will be described. A posture estimation method according to this embodiment estimates the position and the posture of a marker in a camera image captured using a camera.

### <Configuration of Posture Estimation System>

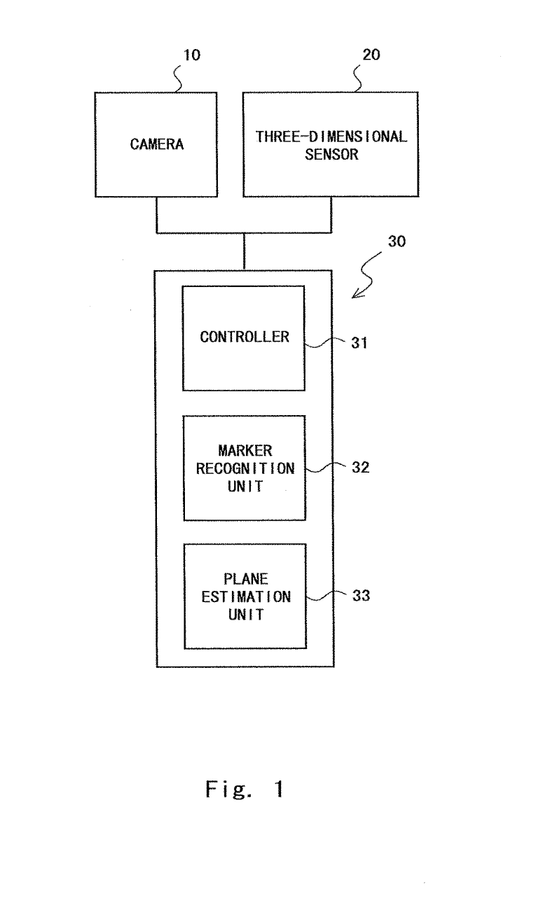

FIG. 1 is a block diagram of an image processing system according to this embodiment. The image processing system includes a camera 10, a three-dimensional sensor 20, and a posture estimation device 30.

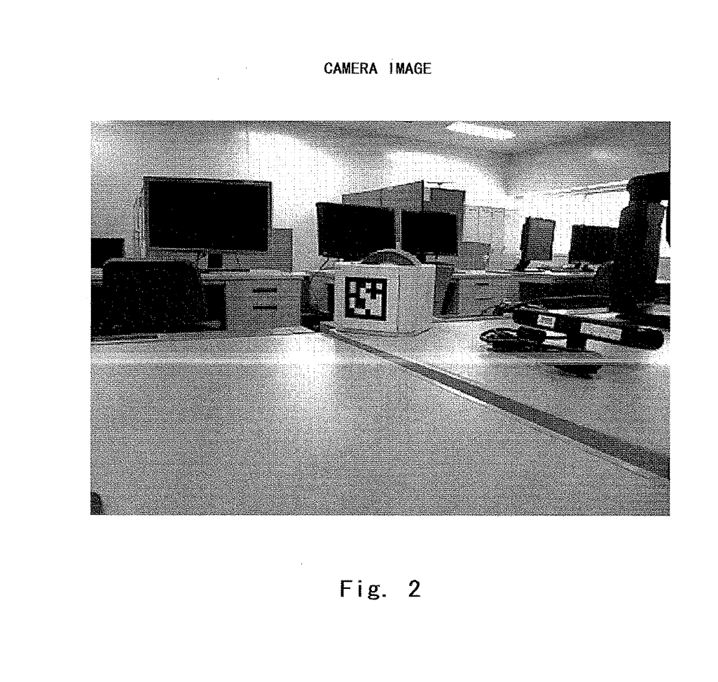

The camera 10 (imaging apparatus) includes a lens group, an image sensor and the like that are not shown. The camera 10 carries out imaging processing to generate a camera image (captured image). In the camera image, the position of each pixel is shown using two-dimensional coordinates (x,y). Further, the camera image is, for example, an image as shown in FIG. 2 and each pixel has an RGB value (color information), a luminance value and the like. The camera 10 is a monocular camera.

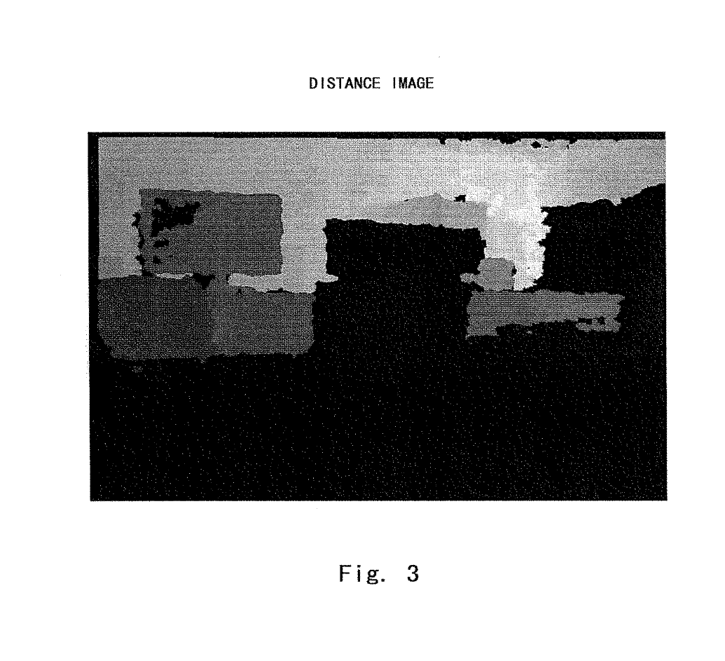

The three-dimensional sensor 20 executes imaging processing to generate a distance image. Specifically, the three-dimensional sensor 20 acquires information (subject distance information) indicating the distance from the camera 10 (or the three-dimensional sensor 20) to a subject in an angle of view corresponding to an angle of view of the camera 10. More specifically, the three-dimensional sensor 20 is disposed in the vicinity of the camera 10 and acquires the distance from the three-dimensional sensor 20 to the subject as the subject distance information. The three-dimensional sensor 20 then generates the distance image using the subject distance information. In the distance image, the position of each pixel is shown using two-dimensional coordinates. Further, in the distance image, each pixel includes subject distance information. That is, the distance image is an image including information regarding the depth of the subject. For example, as shown in FIG. 3, the distance image is a grayscale image and a color density of the pixel is changed in accordance with the subject distance information. The three-dimensional sensor may be, for example, a Time Of Flight (TOF) camera, a stereo camera or the like.

The posture estimation device 30 includes a controller 31, a marker recognition unit 32, and a plane estimation unit 33. The controller 31 is composed of a semiconductor integrated circuit including a Central Processing Unit (CPU), a read only memory (ROM) that stores various programs, and a random access memory (RAM) as a work area or the like. The controller 31 sends an instruction to each block of the posture estimation device 30 and generally controls the whole processing of the posture estimation device 30.

The marker recognition unit 32 detects a marker area (predetermined area) from the camera image. The marker area is a partial area of the camera image, the distance image, and a plane F that has been estimated as will be described below, and is an area including a marker. That is, the position, the posture, and the posture of the marker area correspond to the position, the posture, and the shape of the marker, which is the subject. The marker recognition unit 32 reads out the ID (identification information) of the marker that has been detected. The ID of the marker is attached to the subject by, for example, a format such as a bar code or a two-dimensional code. That is, the marker is a sign to identify the individual, the type and the like of the subject. Further, the marker recognition unit 32 acquires the positional information of the marker area in the camera image. The positional information of the marker area is shown, for example, by using xy coordinates. Note that, in this embodiment, the marker has a substantially rectangular shape.

The plane estimation unit 33 estimates the position and the posture of the marker attached to the subject surface of the subject based on the distance image. Specifically, the plane estimation unit 33 cuts out, from the distance image, the area in the distance image corresponding to the marker area in the camera image. The plane estimation unit 33 acquires the coordinates (two-dimensional coordinates) of the plurality of pixels included in the marker area cut out from the distance image. Further, the plane estimation unit 33 acquires the subject distance information included in each of the plurality of pixels from the distance image. The plane estimation unit 33 then acquires the three-dimensional coordinates of the plurality of pixels based on the subject distance information and the coordinates of the plurality of pixels in the distance image to estimate the position and the posture of the marker included in the marker area.

While the camera 10 and the three-dimensional sensor 20 are arranged close to each other, they are not arranged in the same position. Therefore, there is a slight deviation between the angle of view of the camera image and the angle of view of the distance image. That is, the position (coordinates) of the pixel in one point of one subject in the camera image is different from that in the distance image. However, the gap between the camera 10 and the three-dimensional sensor 20 can be measured in advance. Therefore, the controller 31 is able to deviate the coordinates of the pixel in any one image by the amount corresponding to the gap to associate each pixel of the camera image and each pixel of the distance image. According to this operation, the pixel in one point of one subject in the camera image is associated with that of the distance image (calibration).

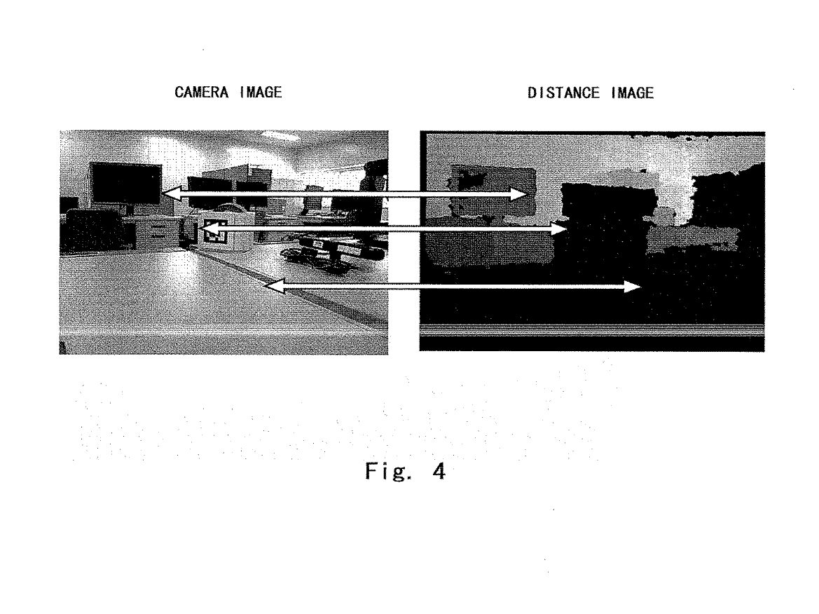

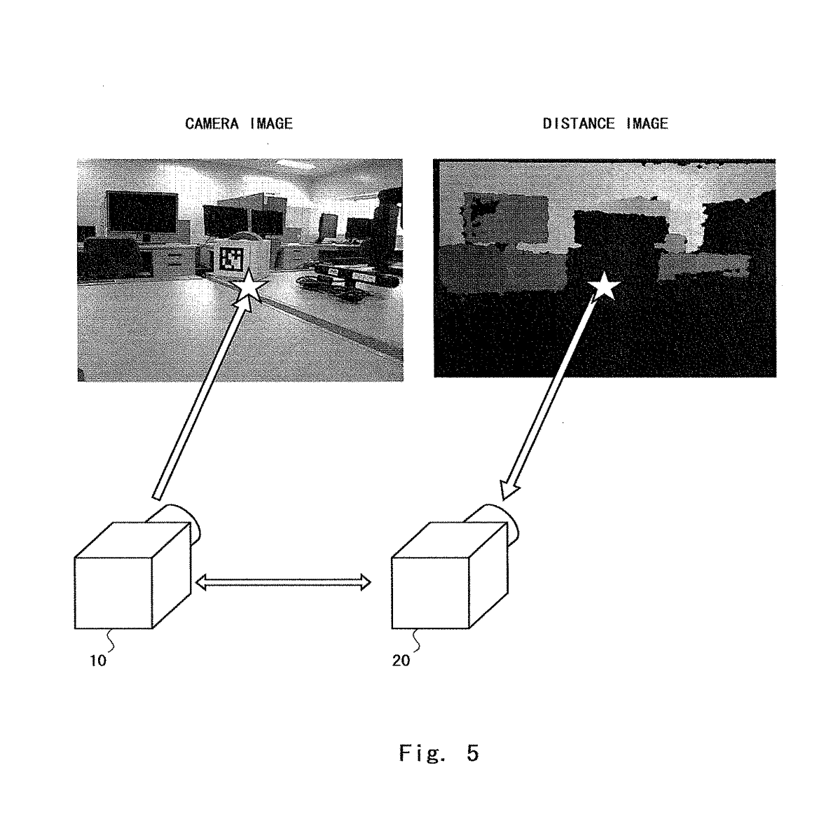

When internal parameters (focal distance, origin (center) position of the image, strain center, aspect ratio and the like) of the camera 10 are the same as those of the three-dimensional sensor 20, it is sufficient that the coordinates of the pixels of the camera image are deviated to associate them with those of the distance image based on the coordinates of the pixels of the distance image as stated above (see FIG. 4). On the other hand, when the internal parameters of the camera 10 are different from the internal parameters of the three-dimensional sensor 20, the coordinates of the camera image are associated with the coordinates of the distance image by projecting each pixel of the distance image onto each pixel of the camera image based on the internal parameters (see FIG. 5). As shown in FIG. 5, the coordinates of the camera image corresponding to the coordinates of the asterisk in the distance image are calculated based on the internal parameters of the camera 10 and the three-dimensional sensor 20. Various calibration methods have been proposed when the two cameras have internal parameters different from each other, and an existing technique may be used. The detailed description of the calibration method will be omitted.

### <Operation of Posture Estimation System>

Next, with reference to a flowchart shown in FIG. 6, a posture estimation method according to this embodiment will be described.

First, the camera 10 and the three-dimensional sensor 20 capture the subject. The camera 10 then generates the camera image. Further, the three-dimensional sensor 20 generates the distance image. The posture estimation device 30 acquires the camera image and the distance image that have been generated (Step S101).

The marker recognition unit 32 detects the marker area from the camera image (Step S102). The marker recognition unit 32 detects the marker area based on the shape of the marker. Since the marker recognition unit 32 stores information that the marker has a substantially rectangular shape in advance, the marker recognition unit 32 detects the rectangular area in the camera image. When there is a marker that can be read out inside the rectangular area, the marker recognition unit 32 detects this rectangular area as the marker area.

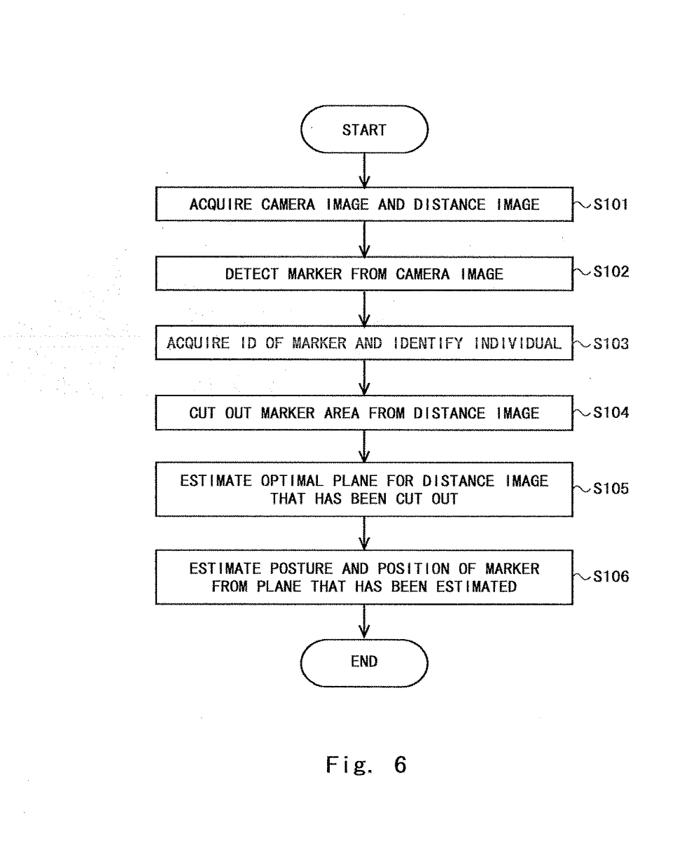

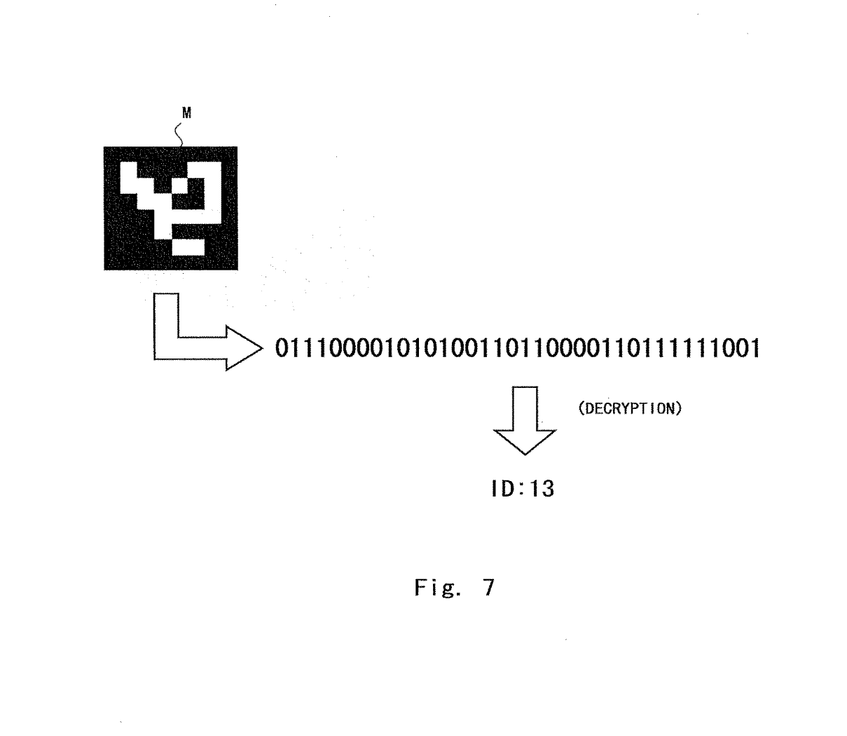

Next, the marker recognition unit 32 reads out the ID of the marker that has been detected (Step S103). It is assumed in this embodiment that a marker M shown in FIG. 7 has been detected. The marker recognition unit 32 reads out the marker M to acquire “13” as the marker ID. In this way, the marker recognition unit 32 acquires the marker ID and identifies the individual of the object to which the marker is attached.

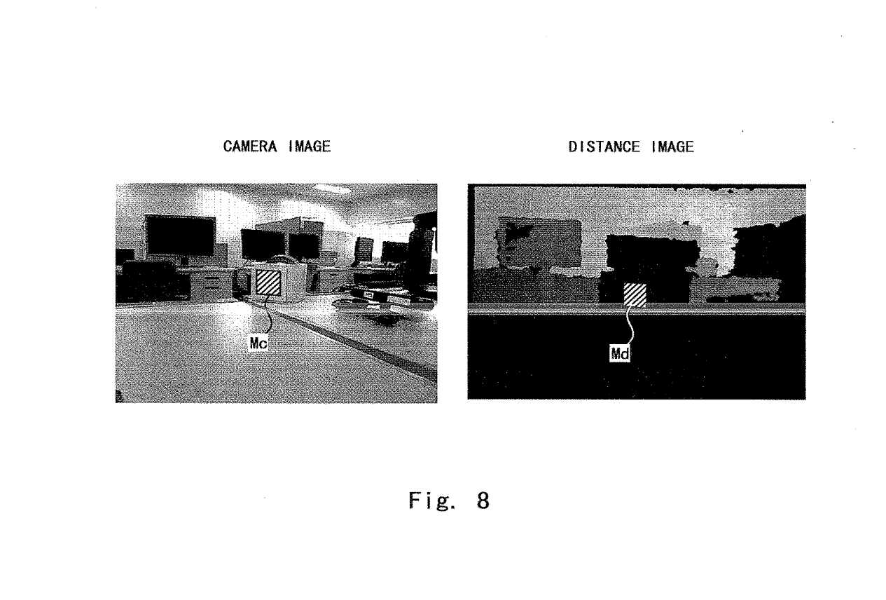

Next, the plane estimation unit 33 cuts out the area in the distance image corresponding to the marker area in the camera image from the distance image (Step S104). Specifically, as shown in FIG. 8, the plane estimation unit 33 acquires the positional information of a marker area Mc (oblique line area) in the camera image from the marker recognition unit 32. Since the coordinates of each pixel of the camera image and the coordinates of each pixel of the distance image are associated with each other in advance, the plane estimation unit 33 cuts out the area corresponding to the position of the marker area in the camera image as a marker area Md (oblique line area) from the distance image.

The plane estimation unit 33 acquires the subject distance information of the plurality of pixels included in the marker area Md cut out from the distance image. Further, the plane estimation unit 33 acquires two-dimensional coordinates (x,y) for the plurality of pixels whose subject distance information has been acquired. The plane estimation unit 33 combines this information to acquire three-dimensional coordinates (x,y,z) for each pixel. According to this operation, the position of each pixel in the marker area Md can be expressed using the three-dimensional coordinates. The marker area where the coordinates of each point are expressed using the three-dimensional coordinates is denoted by a marker area Me.

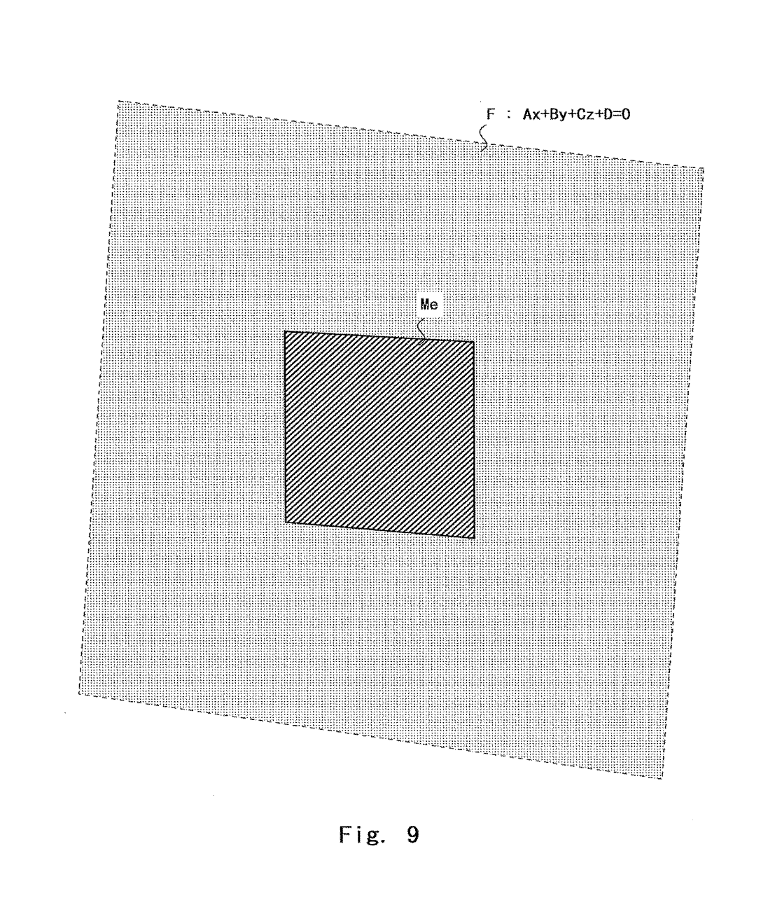

The plane estimation unit 33 estimates the optimal plane for the marker area Me (Step S105). Specifically, as shown in FIG. 9, the plane estimation unit 33 estimates an equation of the optimal plane F using the three-dimensional coordinates of the plurality of pixels included in the marker area Me. The optimal plane F for the marker area Me is a plane that is parallel to the marker area Me and includes the marker area Me. At this time, when three-dimensional coordinates of three or more points are determined in one plane, the equation of the plane is uniquely determined. Therefore, the plane estimation unit 33 estimates the equation of the plane using the three-dimensional coordinates of the plurality of (three or more) pixels included in the marker area Me. It is therefore possible to estimate the equation of the plane including the marker area Me, that is, the direction of the plane. In summary, the direction (posture) of the marker can be estimated.

The equation of the plane is shown using the following expression (1). The symbols A, B, C, and D are constant parameters and x, y, and z are variables (three-dimensional coordinates). A RANdom SAmple Consensus (RANSAC) method may be used, for example, as the method for estimating the equation of the optimal plane. The RANSAC method is a method for estimating the parameters (A, B, C, and D in Expression (1)) using a data set that has been randomly extracted (a plurality of three-dimensional coordinates in the marker area Me), which is a widely-known method. Therefore, a detailed description regarding the RANSAC method will be omitted.

Ax+By+Cz+D=0 (1)

Further, the plane estimation unit 33 estimates the position and the posture of the marker (Step S106). As shown in FIG. 10, the plane estimation unit 33 acquires the three-dimensional coordinates of the pixels at four corners (X0, X1, X2, X3) of the marker area Me in the estimated plane F (X0=(x0,y0,z0). The same is applicable to X1-X3). In the following description, the pixels at the four corners of the marker area (four apices of the marker) are referred to as feature points. The feature points indicate the position and the posture of the marker. When the three-dimensional coordinates of the pixels at the four corners of the marker area can be specified, the position and the posture of the marker can be specified as well. Therefore, the points at the four corners of the marker area are the feature points. As a matter of course, the feature points are not limited to the pixels at the four corners of the marker area.

Alternatively, the expression of each side of the marker area Me may be estimated and the intersections of the respective sides may be estimated as the feature points of the marker area Me. For example, the plane estimation unit 33 may acquire the three-dimensional coordinates of a plurality of points on a side of the marker area Me and estimate the expression of a feasible line as a line that passes the plurality of points, thereby estimating the expression of each side.

The plane estimation unit 33 acquires the three-dimensional coordinates of a center Xa of the four feature points by calculating the average value of the three-dimensional coordinates of the four feature points. The plane estimation unit 33 estimates the three-dimensional coordinates of the center Xa of the marker area as the position of the marker.

Last, the plane estimation unit 33 estimates the marker coordinate system (posture of the marker). As shown in FIG. 10, the plane estimation unit 33 calculates the vector that connects two adjacent points of the four feature points in the marker area. That is, the plane estimation unit 33 estimates the vector that connects the feature points X0 and X3 as the vector (x′) of the marker in the x-axis direction. Further, the plane estimation unit 33 estimates the vector that connects the feature points X0 and X1 as the vector (y′) of the marker in the y-axis direction. Further, the plane estimation unit 33 calculates the normal line of the estimated plane F and estimates the normal vector as the vector (z′) of the marker in the z-axis direction.

At this time, the plane estimation unit 33 may estimate the vector of the marker in the z-axis direction by calculating the outer product of the vector in the x-axis direction and the vector in the y-axis direction that have already been estimated. In this case, it is possible to estimate the coordinate system and the position of the marker using the four feature points of the marker area Me without performing processing for estimating the plane F (Step S105). That is, when the plane estimation unit 33 is able to acquire the subject distance information and the two-dimensional coordinates of the plurality of pixels included in the marker area, the plane estimation unit 33 is able to calculate, from this information, the three-dimensional coordinates of the marker area and to estimate the position and the posture of the marker.

Note that the origin of the coordinate system is, for example, the center Xa of the marker area Me. Therefore, the plane estimation unit 33 estimates the marker coordinate system that is different from the camera coordinate system. As stated above, the plane estimation unit 33 estimates the position and the posture of the marker attached to the subject surface.

As described above, according to the configuration of the posture estimation device 30 in this embodiment, the marker recognition unit 32 acquires the captured image generated by the camera 10 to detect the marker area. The plane estimation unit 33 acquires the three-dimensional coordinates of the plurality of pixels included in the marker area using the coordinates of the plurality of pixels in the marker area and the subject distance of the plurality of pixels in the marker area. Then the plane estimation unit 33 estimates the equation of the plane parallel to the marker area using the three-dimensional coordinates of the plurality of pixels included in the marker area. That is, the plane estimation unit 33 estimates the direction (posture) of the marker. Further, the plane estimation unit 33 estimates the position and the coordinate system (posture) of the marker using the three-dimensional coordinates of the four feature points in the marker area. As stated above, the posture estimation device 30 is able to estimate the position and the posture of the marker using the image generated by the monocular camera and the three-dimensional sensor. In summary, the posture of the subject surface can be estimated using only one camera and one three-dimensional sensor. It is therefore possible to estimate the posture of the subject surface for a low cost without using the stereo camera. Further, since the estimation is performed using the three-dimensional coordinates of the subject surface, high estimation accuracy can be secured as well.

### Second Embodiment

A second embodiment according to the present invention will be described. FIG. 11 shows a block diagram of a posture estimation device 30 according to this embodiment. In this embodiment, a method for estimating the feature points of the marker area by the plane estimation unit 33 is different from that in the above first embodiment. The posture estimation device 30 further includes an accuracy evaluation unit 34. Since the other configurations are similar to those in the first embodiment, the description thereof will be omitted as appropriate.

The plane estimation unit 33 accurately estimates the position of the marker area Me on the projection plane by projecting the coordinates of the marker area Mc in the camera image onto the estimated plane F (hereinafter also referred to as a projection plane F) instead of directly estimating the position and the posture of the marker from the coordinates of the marker area Md cut out from the distance image.

The accuracy evaluation unit 34 evaluates whether the position and the posture of the marker have been accurately estimated. Specifically, the accuracy evaluation unit 34 compares the position of the marker area Me that has been estimated with the position of the marker area Me projected onto the plane F by the plane estimation unit 33 or the position of the marker area Mc in the camera image detected by the marker recognition unit 32. The accuracy evaluation unit 34 evaluates the estimation accuracy based on the comparison result.

### <Operation of Posture Estimation System>

Next, with reference to a flowchart in FIG. 12, an operation of a plane system according to this embodiment will be described. The operations in Steps S201-S205 are similar to those in Steps S101-S105 of the flowchart shown in FIG. 6.

First, the marker recognition unit 32 acquires the camera image generated by the camera 10 and the distance image generated by the three-dimensional sensor (Step S201). The marker recognition unit 32 then detects the marker area Mc in the camera image (Step S202). The marker recognition unit 32 reads out the ID of the marker that has been recognized (Step S203). The plane estimation unit 33 then cuts out the area in the distance image corresponding to the marker area Mc in the camera image (Step S204). The plane estimation unit 33 acquires the three-dimensional coordinates using the subject distance information and the coordinates of the pixels in the marker area Md in the distance image. The plane estimation unit 33 then estimates the direction (equation) of the optimal plane where the marker area Me exists based on the plurality of three-dimensional coordinates (Step S205).

Next, the plane estimation unit 33 projects the marker area Mc in the camera image onto the estimated plane F (Step S206). Specifically, the plane estimation unit 33 acquires the coordinates of the four feature points of the marker area Mc in the camera image with sub-pixel precision. That is, the values of the x and y coordinates of the feature point include not only an integer but also a decimal. The plane estimation unit 33 then projects each of the coordinates that have been acquired onto the projection plane F to calculate the three-dimensional coordinates of the four feature points of the marker area Me on the projection plane F. The three-dimensional coordinates of the four feature points of the marker area Me on the projection plane F can be calculated by performing projective transformation (central projection transformation) using the internal parameters (focal distance, image central coordinates) of the camera 10.

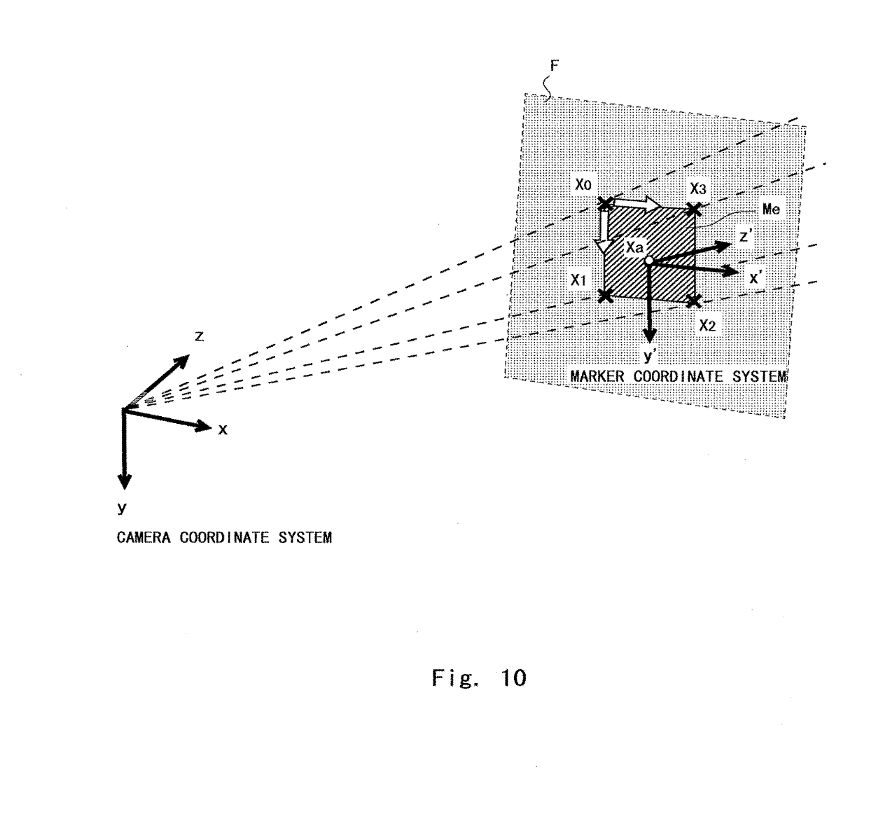

More specifically, as shown in FIG. 13, the coordinates of the four feature points Ti(T0-T3) of the marker area Mc in the camera image C are expressed by (ui,vi) and the three-dimensional coordinates of the four feature points Xi(X0-X3) of the marker area Me on the projection plane are expressed by (xi,yi,zi). At this time, the following expressions (2)-(4) are satisfied for the corresponding coordinates in the camera image and the projection plane. The symbol fx indicates the focal distance of the camera 10 in the x direction and fy indicates the focal distance of the camera 10 in the y direction. Further, the symbols Cx and Cy indicate the central coordinates of the camera image.

$$\begin{matrix}{Ax}_{i} + {By}_{i} + {Cz}_{i} + D = 0 & ( 2 ) \\ {x}_{i} = \frac{( {u}_{i} - {C}_{x} ) \times {z}_{i}}{{f}_{x}} & ( 3 ) \\ {y}_{i} = \frac{( {v}_{i} - {C}_{y} ) \times {z}_{i}}{{f}_{y}} & ( 4 )\end{matrix}$$

The above expression (2) is an expression of the plane F (projection plane) including the marker area Me. The expressions (3) and (4) are expressions of the dashed lines that connect the feature points in the camera image C and the feature points on the plane F in FIG. 13. Therefore, in order to obtain the three-dimensional coordinates of the feature points (X0-X3) of the marker area Me on the projection plane F, the simultaneous equations from Expressions (2) to (4) may be calculated for each point (T0-T3) of the feature points of the marker area Mc in the camera image C. The symbol i denotes the number of the feature points.

After calculating the three-dimensional coordinates of the feature points of the marker area Me on the projection plane F, the plane estimation unit 33 estimates the position and the posture of the marker (Step S207). Specifically, the plane estimation unit 33 calculates the average value of the four feature points of the marker area Me (coordinates of the center Xa of the marker area Me) to acquire the three-dimensional coordinates indicating the position of the marker. Further, the plane estimation unit 33 estimates the vector in the x-axis direction and the vector in the y-axis direction of the marker using the three-dimensional coordinates of the four feature points of the marker area Me. Further, the plane estimation unit 33 estimates the vector in the z-axis direction by calculating the normal line of the projection plane F. The plane estimation unit 33 may estimate the vector in the z-axis direction by calculating the outer product of the vector in the x-axis direction and the vector in the y-axis direction. The plane estimation unit 33 thus estimates the marker coordinate system (posture of the marker).

Last, the accuracy evaluation unit 34 evaluates the reliability of the estimation accuracy of the position and the posture of the marker that have been estimated (Step S208). The evaluation method may be an evaluation method in a three-dimensional space (estimated plane F) or an evaluation method in a two-dimensional space (camera image).

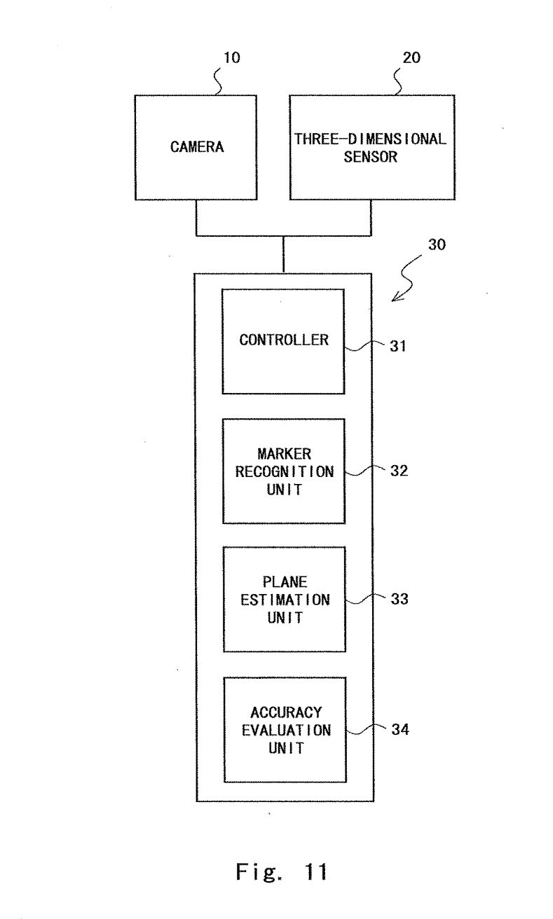

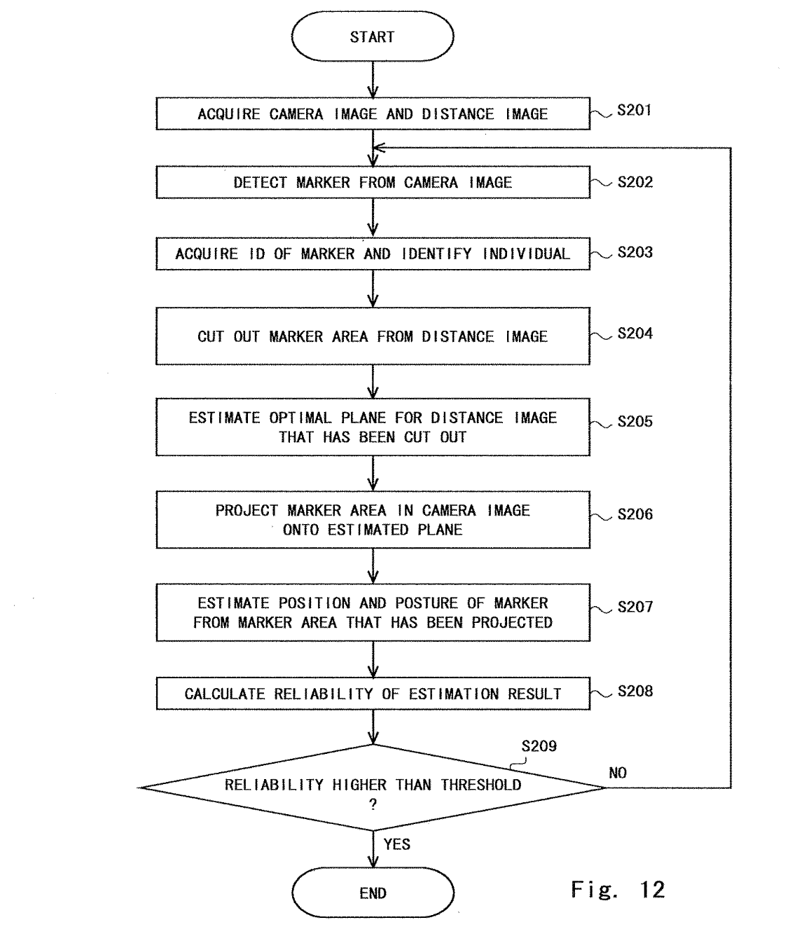

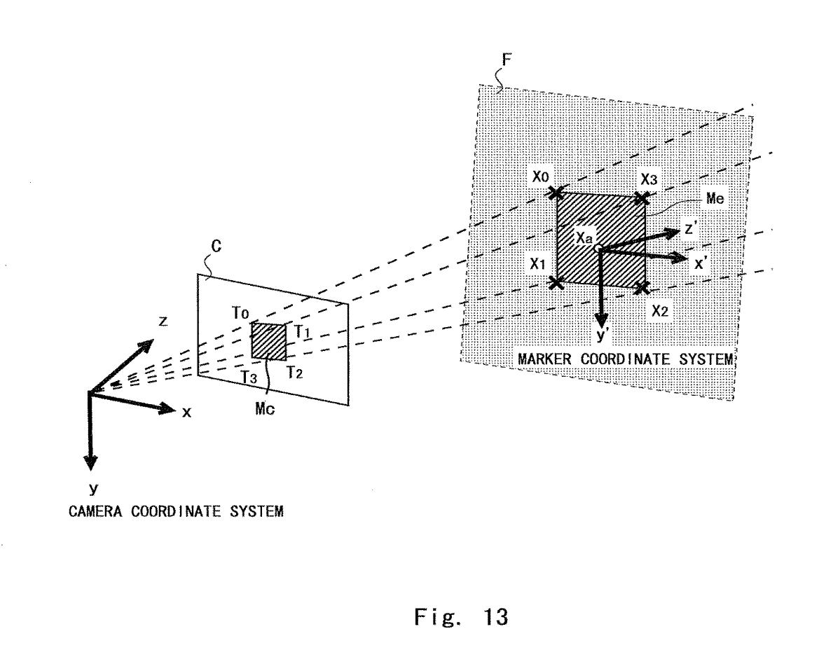

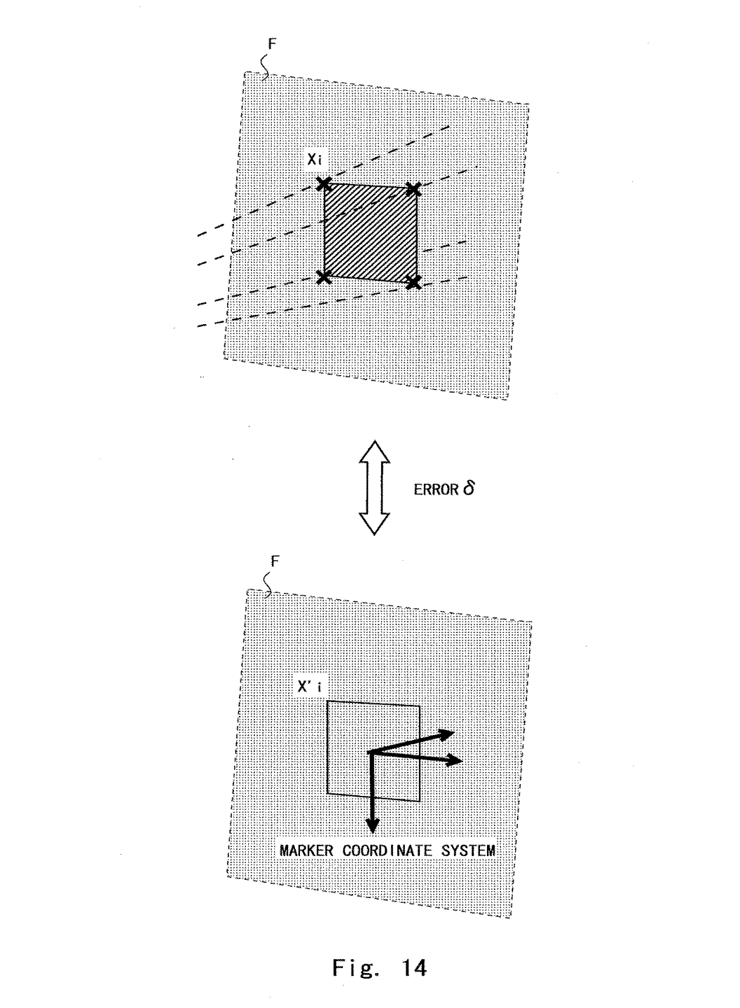

First, with reference to FIG. 14, the evaluation method in the three-dimensional space will be described. The accuracy evaluation unit 34 compares the three-dimensional coordinates of the marker area Me projected onto the projection plane F by the plane estimation unit 33 with the three-dimensional coordinates of the marker area calculated using the position and the posture of the marker that has been estimated and the size of the marker to calculate an error 6 of the three-dimensional coordinates. For example, the accuracy evaluation unit 34 calculates the error 6 for the three-dimensional coordinates of the feature points of the marker area using the following expression (5). Note that X denotes the three-dimensional coordinates of the feature points of the marker area Me projected onto the projection plane from the camera image and X′ denotes the three-dimensional coordinates of the feature points of the marker area that has been estimated. Specifically, the feature point X′ is a feature point of the marker to be estimated based on the estimated position of the marker (three-dimensional coordinates of the center of the marker), the estimated marker coordinate system, and the shape or the length of each side of the marker set in advance (acquired by the accuracy evaluation unit 34 in advance). The symbol i denotes the number of the feature points.

$$δ = {\sum }_{i = 0}^{N} {‖ {X}_{i}^{′} - {X}_{i} ‖}^{2} ( N = 3 ) \qquad ( 5 )$$

The accuracy evaluation unit 34 determines the reliability of the position and the posture of the marker that have been estimated using the following expression (6). Note that a denotes the reliability and θ denotes a threshold of the error where the reliability becomes 0.

$$α = \{ \begin{matrix}1 - \frac{δ}{θ} & if δ < θ \\ 0 & otherwise\end{matrix} \qquad ( 6 )$$

The accuracy evaluation unit 34 determines whether the reliability α is higher than the threshold (Step S209). When the reliability α is higher than the threshold (Step S209: Yes), the accuracy evaluation unit 34 employs the estimation result and the flow is ended. On the other hand, when the reliability α is equal to or lower than the threshold (Step S209: No), the accuracy evaluation unit 34 discards the estimation result. The posture estimation device 30 then re-executes the above processing from the marker detection processing (Step S202). For example, the accuracy evaluation unit 34 employs the estimation result when the reliability α is equal to or larger than 0.8 and discards the estimation result when the reliability α is lower than 0.8.

Next, with reference to FIG. 15, the evaluation method in the two-dimensional space will be described. The accuracy evaluation unit 34 projects the marker area estimated on the projection plane onto the plane of the camera image again in consideration of the position and the posture of the marker that have been estimated, and the size of the marker. The accuracy evaluation unit 34 then compares the position of the marker area that has been projected with the position of the marker area Mc in the camera image to calculate the error δ of the two-dimensional coordinates. For example, the accuracy evaluation unit 34 calculates the error 6 for the two-dimensional coordinates of the feature points of the marker area using the following expression (7). Note that P denotes the two-dimensional coordinates of the feature points of the marker area Mc in the camera image (when the subject is captured), P′ denotes the two-dimensional coordinates of the feature point of the marker area when the feature point X′ (the same as X′ in FIG. 14) of the marker that has been estimated is projected onto the camera image, and i denotes the number of the feature points.

$$δ = {\sum }_{i = 0}^{N} {‖ {P}_{i}^{′} - {P}_{i} ‖}^{2} ( N = 3 ) \qquad ( 7 )$$

The reliability α can be calculated using an expression similar to the above expression (6). The accuracy evaluation unit 34 may evaluate the estimation accuracy using one or both of the evaluation methods stated above.

As described above, according to the configuration of the posture estimation device 30 in this embodiment, the plane estimation unit 33 projects the marker area Mc in the camera image onto the projection plane estimated as the plane including the marker. The plane estimation unit 33 estimates the position and the posture of the marker using the three-dimensional coordinates of the four feature points of the marker area Me projected onto the projection plane F. At this time, when the estimation is carried out using only the subject distance information and the coordinates of the marker area Md cut out from the distance image as described in the first embodiment, an error may occur in the estimation of the three-dimensional coordinates of the feature points due to an influence of an error that occurs when the marker area is cut out. Meanwhile, in this embodiment, the plane estimation unit 33 calculates the three-dimensional coordinates of the four feature points of the marker area Me by projecting the feature points in the camera image onto the estimated projection plane F. Therefore, it is possible to estimate the position and the posture of the marker area without being influenced by the cut-out error. As a result, the estimation accuracy can be improved.

Further, the plane estimation unit 33 specifies the coordinates of the feature points in the camera image with sub-pixel precision when the marker area Mc is projected. It is therefore possible to carry out an estimation with higher accuracy than in the case in which the estimation is carried out for each pixel.

Further, the accuracy evaluation unit 34 evaluates the estimation accuracy of the marker area that has been estimated, and when the estimation accuracy is equal to or lower than the threshold, discards the estimation result. It is therefore possible to employ only a highly accurate estimation result. Further, when the accuracy of the estimation result is low, such an operation may be performed, for example, that the estimation is carried out again. It is therefore possible to acquire an estimation result having sufficiently high accuracy.

### Modified Example

A modified example according to this embodiment will be described. In this modified example, the subject surface to which the marker is attached is a curved surface, not a plane. That is, the posture estimation device 30 estimates an optimal primitive shape for the marker area cut out from the distance image. Since the configuration of the posture estimation device 30 is similar to that shown in FIG. 11, the detailed description will be omitted as appropriate.

A processing similar to that shown in the flowchart in FIG. 12 is performed in a posture estimation method according to the modified example. First, the marker recognition unit 32 detects the marker from the camera image. As shown in FIG. 16, in the modified example, it is assumed that the marker is attached to a columnar subject surface. That is, the marker has a shape of a curved surface.

The marker recognition unit 32 reads out the ID of the marker that has been recognized. As shown in FIG. 17, the plane estimation unit 33 cuts out the area Md in the distance image corresponding to the marker area Mc in the camera image.

Next, the plane estimation unit 33 acquires the three-dimensional coordinates of the plurality of pixels based on the subject distance information and the coordinates of the plurality of pixels included in the marker area Md that has been cut out. The plane estimation unit 33 estimates an equation of a column E to which the marker is attached using the three-dimensional coordinates that have been acquired, for example, by the RANSAC method (see FIG. 18). At this time, the equation of the column is expressed by the following expression (8). The symbols a, b, and r are constant parameters. The symbol r is a radius of the column. It is assumed that the plane estimation unit 33 recognizes that the marker has a curved surface in advance. For example, the shape of the marker may be input by a user in advance or information on the shape of the marker may be included in the information of the marker that has been read out.

(x−a)²+(y−b)²=r² (8)

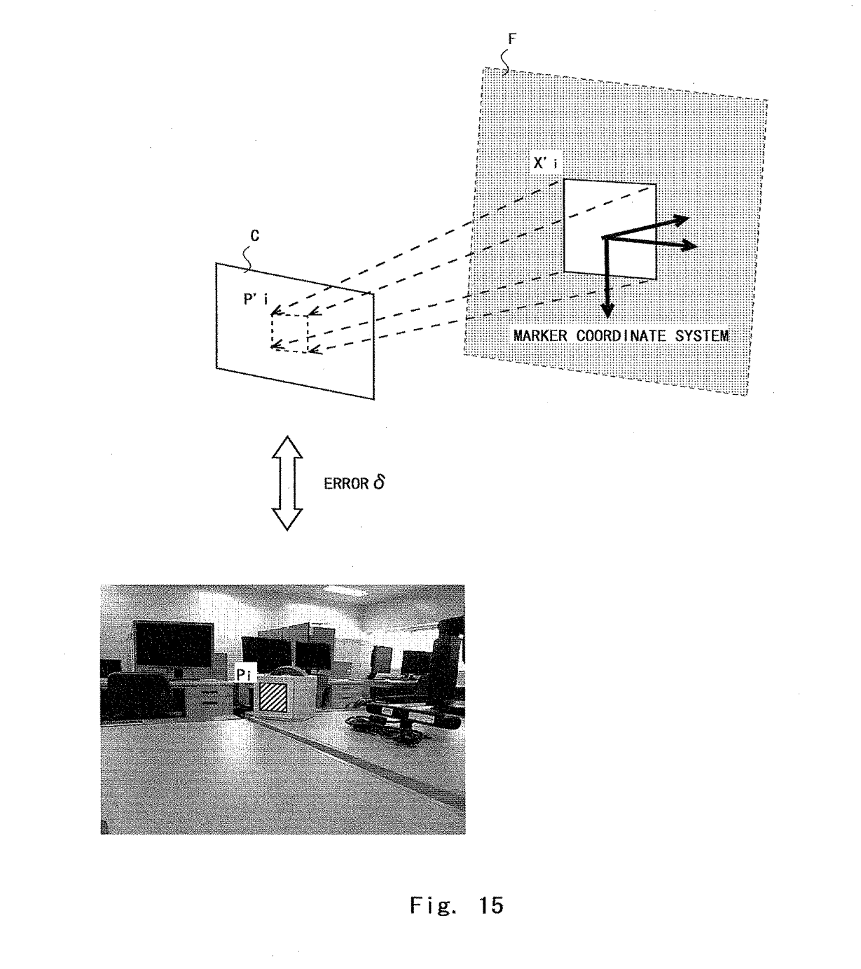

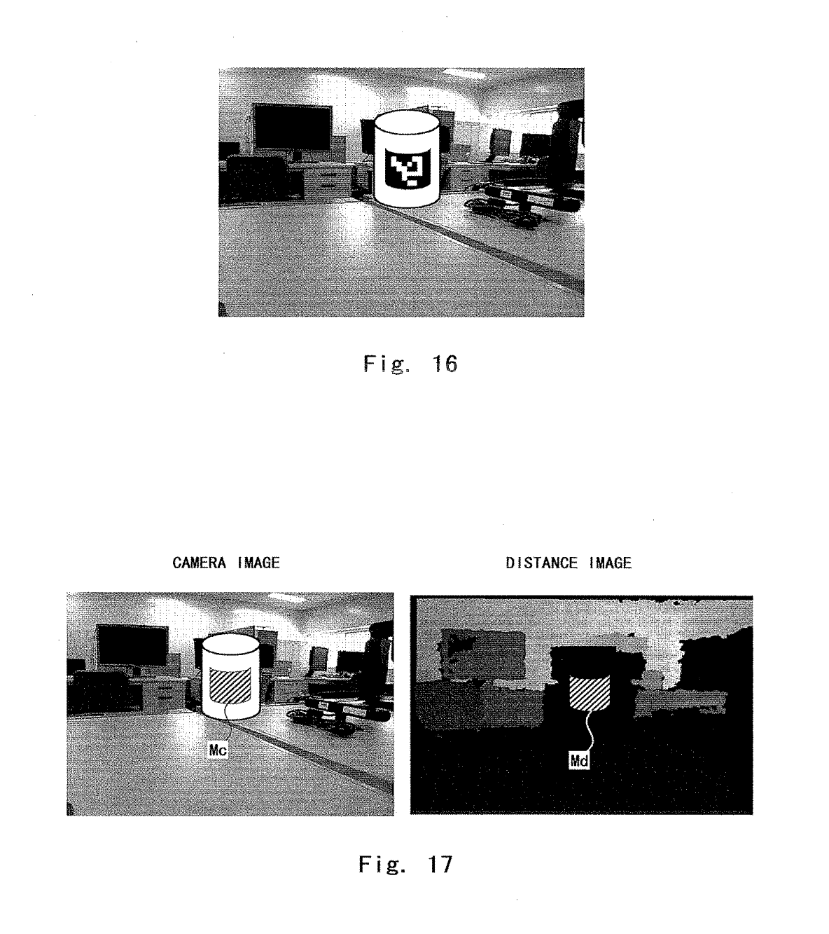

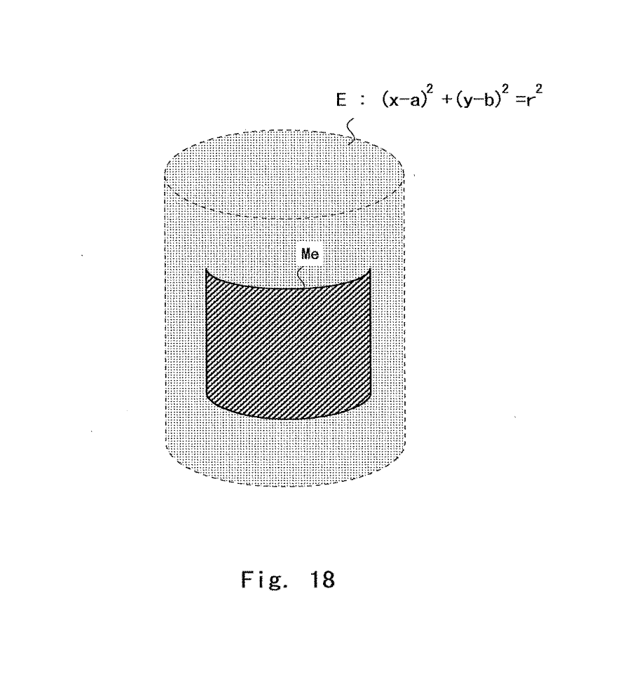

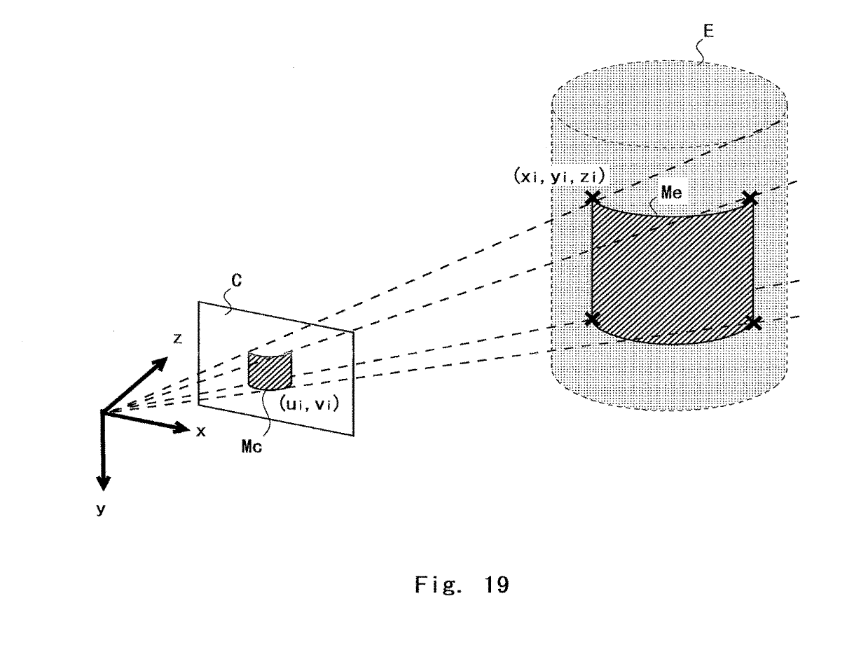

After estimating the equation of the column, the plane estimation unit 33 projects the marker area Mc in the camera image onto the estimated column E. That is, the plane estimation unit 33 projects, as shown in FIG. 19, the coordinates of the pixels of the feature points of the marker area Mc in the camera image C as the three-dimensional coordinates on the side surface of the estimated column E using the expressions (3), (4), and (8).

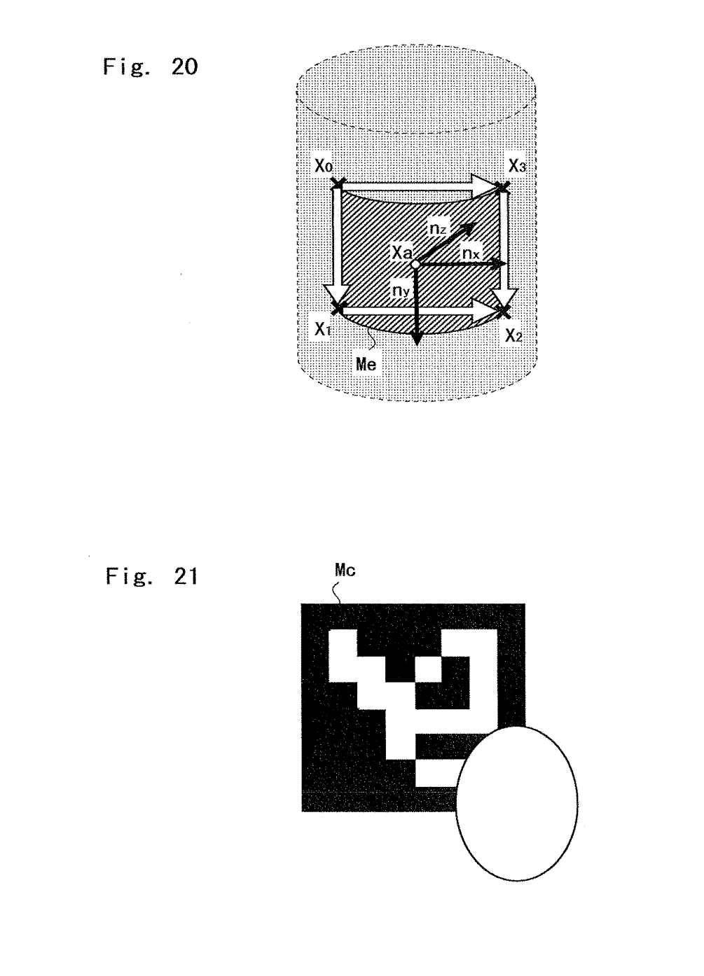

The plane estimation unit 33 estimates the position of the marker using the three-dimensional coordinates of the feature points of the marker area Me in the estimated column. As shown in FIG. 20, the plane estimation unit 33 estimates, for example, the three-dimensional coordinates of the center Xa of the marker area Me as the position of the marker. The three-dimensional coordinates of the center Xa of the marker area Me can be obtained by calculating the following expression (9) using, for example, the three-dimensional coordinates of the feature points (X0-X3) of the marker area Me.

$$Xa = \frac{1}{N} {\sum }_{i = 0}^{N} {X}_{i} ( N = 3 ) \qquad ( 9 )$$

That is, the position of the marker is indicated by the average value of the three-dimensional coordinates of the four feature points. Note that Xi indicates the i-th feature point of the marker area. Xi=(xi,yi,zi) is satisfied.

Next, the plane estimation unit 33 estimates the marker coordinate system (posture of the marker). Specifically, as shown in FIG. 20, the plane estimation unit 33 calculates the average of the vector that connects the feature points X0 and X3 and the vector that connects the feature points X1 and X2 of the marker area Me in the x-axis direction using the following expression (10) to estimate a vector nx in the x-axis direction.

nₓ=½{(X₃−X₀)+(X₂+X₁)} (10)

In a similar way, the plane estimation unit 33 calculates the average of the vector that connects the coordinates of the feature points X0 and X1 and the vector that connects the feature points X2 and X3 of the marker area Me in the y-axis direction using the following expression (11) to estimate a vector ny in the y-axis direction.

n_{y}=½{(X₁−X₀)+(X₂+X₃)} (11)

Further, the plane estimation unit 33 estimates a vector nz in the z-axis direction of the marker area Me using the following expression (12). That is, the vector nz can be obtained by the outer product of the vector nx and the vector ny that have already been calculated.

n_{z}=nₓ×n_{y} (12)

Last, the posture of the marker R is expressed using the following expression (13). That is, the posture of the marker R normalizes the vectors in the x-axis direction, the y-axis direction, and the z-axis direction, and is expressed using the rotation matrix.

$$R = ( \begin{matrix}\frac{{n}_{x}}{‖ {n}_{x} ‖} & \frac{{n}_{y}}{‖ {n}_{y} ‖} & \frac{{n}_{z}}{‖ {n}_{z} ‖}\end{matrix} ) \qquad ( 13 )$$

As shown in the following expression (14), the position and the posture of the marker that have been calculated are expressed using a position posture matrix Σ^{mrk} of the marker.

$${\sum }^{mrk} = ( \begin{matrix} & R & & {X}_{a} \\ 0 & 0 & 0 & 1\end{matrix} ) \qquad ( 14 )$$

As stated above, even when the marker is attached to the curved surface, the posture estimation device 30 according to this embodiment acquires the three-dimensional coordinates of the marker area Me to estimate the curved surface (column) including the marker. The posture estimation device 30 then projects the feature points of the marker area Mc in the camera image onto the estimated curved surface and calculates the feature points of the marker on the curved surface (column E). It is therefore possible to estimate the position and the posture of the marker.

### Third Embodiment

A third embodiment according to this embodiment will be described. A posture estimation device 30 according to this embodiment estimates the position and the posture of the marker in a state in which a part of the marker in the camera image is hidden. Since the basic estimation method is the same as that in the flowcharts in FIGS. 6 and 12, the detailed description thereof will be omitted as appropriate.

### <When One Feature Point of Marker is Hidden>

First, as shown in FIG. 21, the estimation method when one of the four feature points of the marker is hidden will be described. First, the marker recognition unit 32 detects the marker area Mc in the camera image.

At this time, since one feature point of the marker is hidden, the number of feature points that can be detected by the marker recognition unit 32 is three. Therefore, the marker recognition unit 32 cannot recognize the rectangular marker area. Therefore, as shown in FIG. 22, the marker recognition unit 32 extends two sides L1 and L2 extending to a feature point T2 that is hidden in the camera image. When the two sides L1 and L2 that have been extended intersect with each other, the marker recognition unit 32 estimates the intersection as the feature point T2 that is hidden. When the area formed of four points has a substantially rectangular shape, the marker recognition unit 32 determines that this area is the marker area Mc.

When the color of the marker is characteristic, the marker recognition unit 32 may detect the marker area Mc using color information specific to the marker. For example, as shown in FIG. 21, when the marker has a rectangular shape whose color includes only black and white, the marker recognition unit 32 determines the area whose color includes only black and white to be the marker area.

Next, the plane estimation unit 33 estimates the plane including the marker area Me. That is, the plane estimation unit 33 cuts out the area corresponding to the area determined to be the marker area Mc in the camera image from the distance image. The plane estimation unit 33 acquires the three-dimensional coordinates calculated from the subject distance information and the coordinates of the plurality of pixels included in the marker area Md in the distance image to estimate the plane including the marker area Me (equation of the plane).

The plane estimation unit 33 then projects three feature points T0, T1, and T3 of the marker area Mc recognized in the camera image onto the estimated plane (projection plane) using the above expressions (2)-(4). The plane estimation unit 33 therefore acquires the three-dimensional coordinates on the projection plane of the three feature points X0, X1, and X3 of the marker area Me.

Next, the plane estimation unit 33 calculates, as shown in FIG. 23, using the three-dimensional coordinates of the two feature points X1 and X3 that are not adjacent to each other from among the three feature points X0, X1, and X3 that have been recognized in the camera image, the line segment (diagonal line of the marker) that connects these two points. The plane estimation unit 33 then acquires the three-dimensional coordinates of the midpoint Xa of the diagonal line. The plane estimation unit 33 therefore acquires the three-dimensional coordinates of the center Xa of the marker area Me as the coordinates indicating the position of the marker.

Further, the plane estimation unit 33 estimates the marker coordinate system. Specifically, the plane estimation unit 33 calculates the vectors of the two sides that connect the three feature points X0, X1, and X3 of the marker area Me that have been recognized. As shown in FIG. 24, the plane estimation unit 33 estimates the vector from the feature point X0 to the feature point X3 as the vector in the x-axis direction. Further, the plane estimation unit 33 estimates the vector from the feature point X0 to the feature point X1 as the vector in the y-axis direction. Then, the plane estimation unit 33 calculates the normal line of the plane including the marker area Me as the vector in the z-axis direction. According to this operation, the plane estimation unit 33 estimates the marker coordinate system (posture of the marker). The vector in the z-axis direction may also be obtained by calculating the outer product of the vector in the x-axis direction and the vector in the y-axis direction that have already been calculated.

### <When Two Feature Points of Marker are Hidden>

Next, the estimation method in a case in which two of the four feature points of the marker are hidden will be described. As shown in FIG. 25, it is assumed that two feature points that are adjacent to each other of the four feature points of the marker are hidden.

First, the marker recognition unit 32 specifies the marker area Mc in the camera image. When two feature points of the marker that are adjacent to each other are hidden, the number of feature points that can be detected by the marker recognition unit 32 is two. Since a rectangle cannot be formed by only extending the sides of the marker that could have been recognized, it is difficult to detect the marker area Mc based on the shape. Therefore, the marker recognition unit 32 detects the marker area Mc based on the color information specific to the marker.

Next, the plane estimation unit 33 estimates the plane including the marker area Me. That is, the plane estimation unit 33 cuts out the area in the distance image corresponding to the area determined to be the marker area Mc in the camera image from the distance image. Then the plane estimation unit 33 acquires the three-dimensional coordinates calculated from the subject distance information and the coordinates of the plurality of pixels included in the marker area Md in the distance image to estimate the plane including the marker area Me (equation of the plane).

The plane estimation unit 33 then projects the two feature points in the marker area Mc recognized in the camera image onto the estimated plane (projection plane) using the above Expressions (2) to (4). Further, the plane estimation unit 33 estimates the three-dimensional coordinates of the two feature points that are hidden on the estimated plane. It is assumed, for example, that the plane estimation unit 33 acquires the shape information of the marker in advance. The shape information is information indicating whether the rectangular marker is a square, the ratio of the length of each side, the length of each side and the like. The plane estimation unit 33 then estimates the three-dimensional coordinates of the two feature points that are hidden using the shape information of the marker.

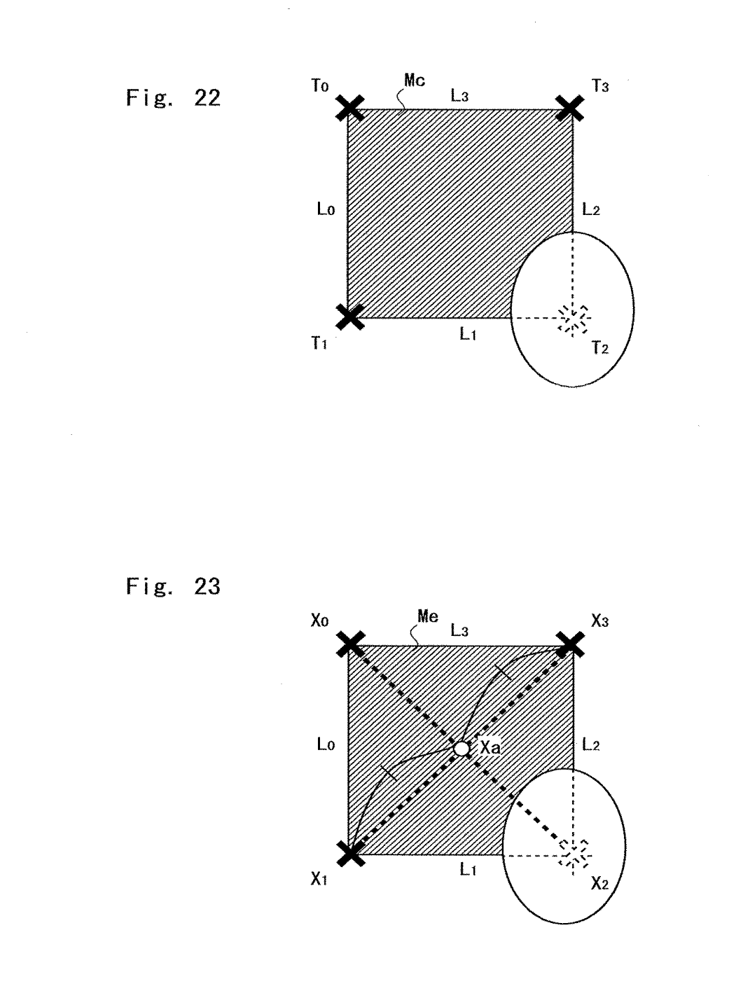

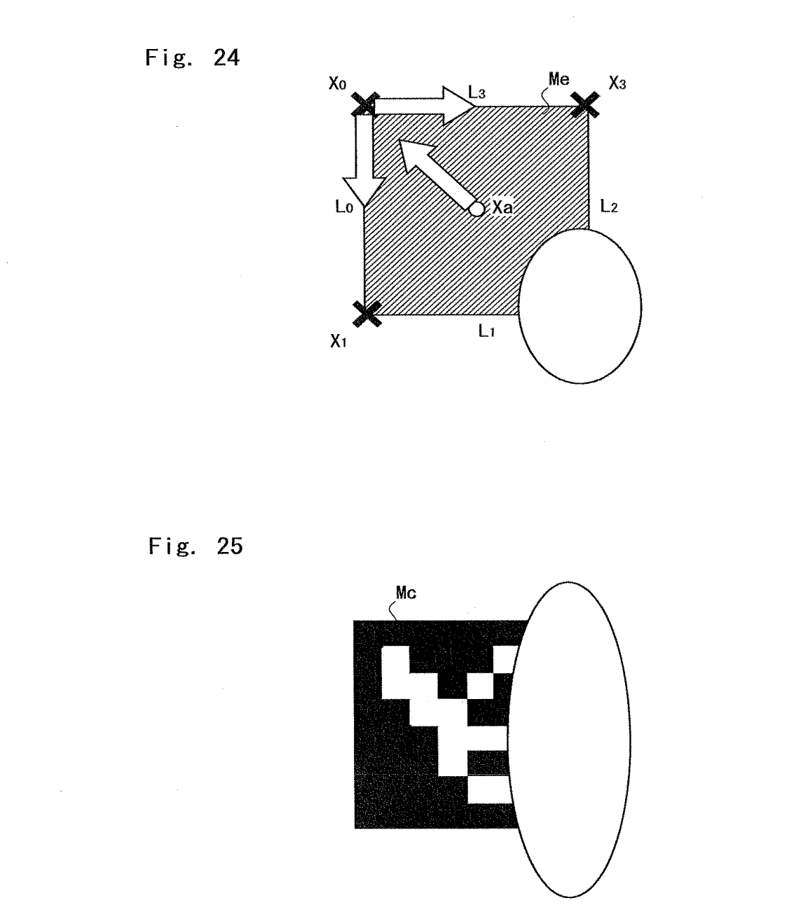

It is assumed, for example, as shown in FIG. 26, that the plane estimation unit 33 includes the shape information indicating that the marker is a square. In this case, the plane estimation unit 33 estimates the points as the feature points X2 and X3 that satisfy all the following conditions: they are positioned on the estimated plane, they are located on the lines obtained by extending the sides L1 and L3 extending to the feature points that are hidden, and the distance of these points from the feature points X0 and X1 that have been recognized is the same as the distance between two points (X0, X1) that have been recognized. The plane estimation unit 33 thus acquires the three-dimensional coordinates of all the feature points in the marker area Me. Then as shown in FIG. 27, the plane estimation unit 33 estimates the average value of the three-dimensional coordinates of all the feature points in the marker area Me as the coordinates of the center Xa indicating the position of the marker. Further, the plane estimation unit 33 may estimate the three-dimensional coordinates of the intersection of the diagonal lines or the midpoint of the diagonal lines as the coordinates indicating the position of the marker.

Further, the plane estimation unit 33 estimates the marker coordinate system. Specifically, as shown in FIG. 28, the plane estimation unit 33 estimates the vector that connects the feature points X0 and X1 recognized in the camera image as the vector in the y-axis direction. Further, the plane estimation unit 33 estimates the normal line on the estimated plane as the vector in the z-axis direction. The plane estimation unit 33 then estimates the outer product of the vector in the y-axis direction and the vector in the z-axis direction that have already been calculated as the vector in the x-axis direction. According to this operation, the plane estimation unit 33 estimates the marker coordinate system (posture of the marker).

### <When Two Feature Points of Marker are Hidden>

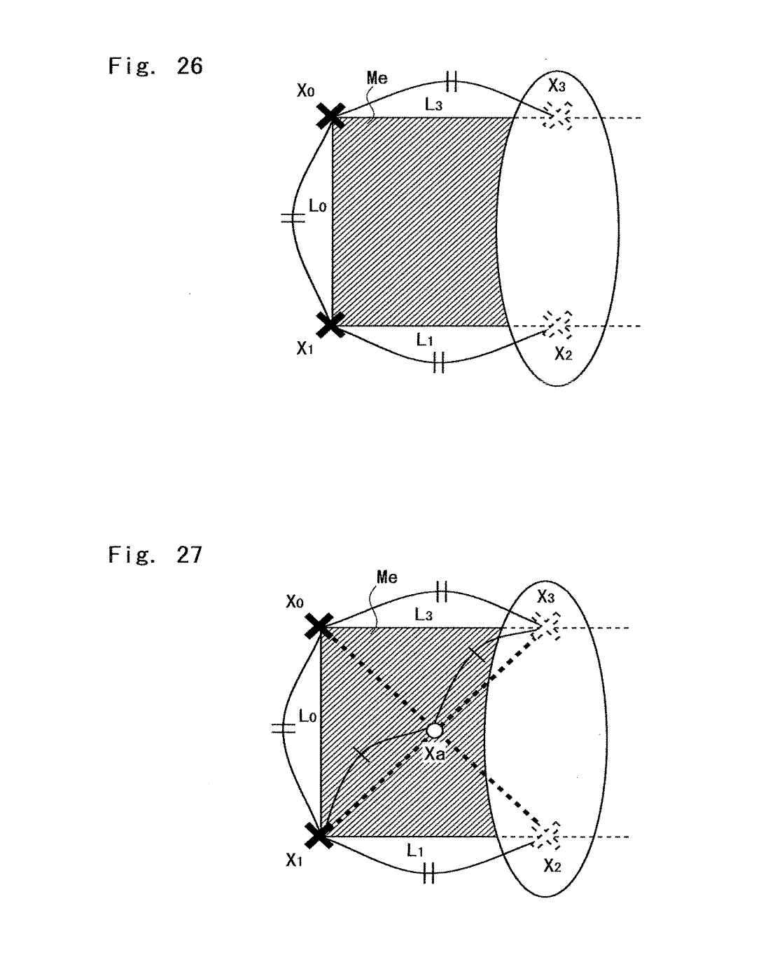

Next, the estimation method in a case in which two of the four feature points of the marker are hidden will be described. It is assumed, as shown in FIG. 29, that the two feature points located on the diagonal line are hidden among the four feature points of the marker. First, the marker recognition unit 32 detects the marker area Mc in the camera image. The number of feature points that the marker recognition unit 32 can detect is two. It is therefore difficult to detect the marker area Mc based on the shape. Accordingly, the marker recognition unit 32 detects the marker area Mc based on the color information specific to the marker, similar to the case in which two feature points that are adjacent to each other are hidden.

Next, the plane estimation unit 33 estimates the plane including the marker area Me. That is, the plane estimation unit 33 cuts out the area in the distance image corresponding to the area determined to be the marker area Mc in the camera image from the distance image. Then, the plane estimation unit 33 acquires the three-dimensional coordinates calculated from the subject distance information and the coordinates of the plurality of pixels included in the marker area Md in the distance image to estimate the plane including the marker area Me (equation of the plane).

The plane estimation unit 33 then projects the coordinates of the two feature points in the marker area Mc recognized in the camera image onto the estimated plane (projection plane) using Expressions (2) to (4).

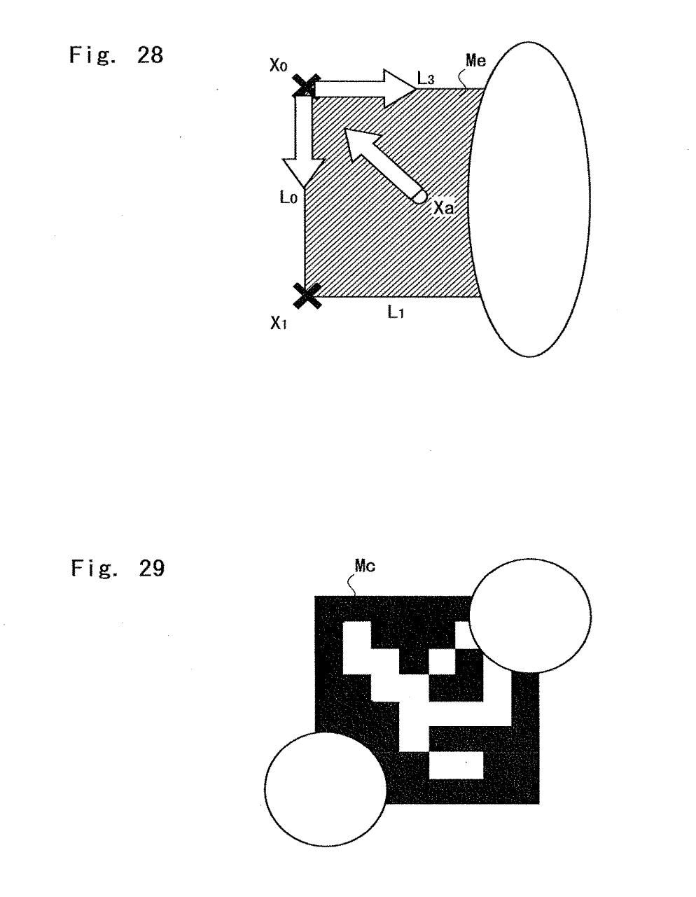

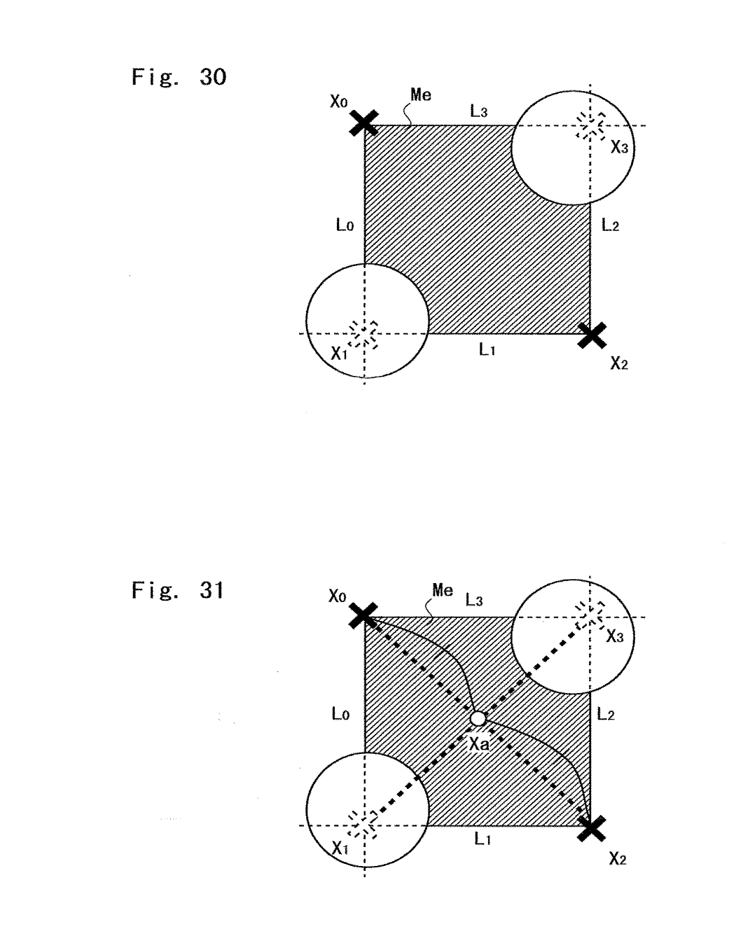

Further, as shown in FIG. 30, the plane estimation unit 33 extends each of the two sides L0 and L3 extending from the feature point X0 that could have been recognized in the camera image in the marker area Me projected onto the projection plane. Further, the plane estimation unit 33 extends each of the two sides L1 and L2 extending from the feature point X2 recognized in the camera image. The plane estimation unit 33 then estimates that the intersections of the extended sides are the feature points X1 and X3 of the marker area Me. More specifically, the plane estimation unit 33 estimates the points that satisfy the conditions that the points are located on the estimated plane and the points are on the lines obtained by extending the sides L1 and L2 as the two feature points X1 and X3 that are hidden. As shown in FIG. 31, the plane estimation unit 33 estimates the average value of the three-dimensional coordinates of the four feature points as the coordinates of the center Xa indicating the position of the marker. That is, the plane estimation unit 33 estimates the coordinates of the center Xa of the marker area Me.

Further, as shown in FIG. 32, the plane estimation unit 33 estimates the vectors that connect two feature points that are adjacent to each other of the four feature points of the marker as the vector in the x-axis direction and the vector in the y-axis direction. Further, the plane estimation unit 33 estimates the normal vector of the plane including the marker area Me as the vector in the z-axis direction. The plane estimation unit 33 therefore estimates the marker coordinate system (posture of the marker).

### <When Three Feature Points of Marker are Hidden>

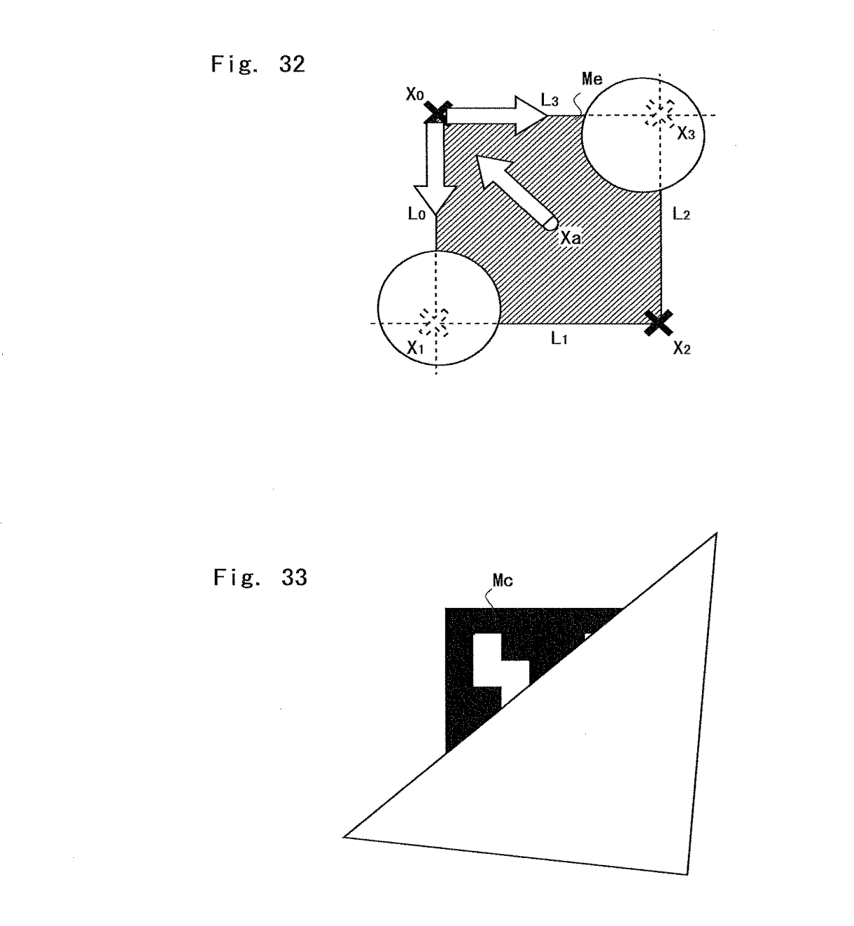

Next, as shown in FIG. 33, the estimation method in a case in which three of the four feature points of the marker are hidden will be described. The number of feature points that can be detected by the marker recognition unit 32 is one. It is therefore difficult to detect the marker area Mc based on the shape. Therefore, first, the marker recognition unit 32 detects the marker area Mc in the camera image based on the color information specific to the marker.

Next, the plane estimation unit 33 estimates the plane including the marker area Me. That is, the plane estimation unit 33 cuts out the area in the distance image corresponding to the area recognized to be the marker area Mc in the camera image from the distance image. Then the plane estimation unit 33 acquires the three-dimensional coordinates calculated from the subject distance information and the coordinates of the plurality of pixels included in the marker area Md in the distance image to estimate the plane including the marker area Me (equation of the plane).

The plane estimation unit 33 then projects the coordinates of one feature point of the marker area Mc that could have been recognized in the camera image onto the estimated plane using Expressions (2) to (4).

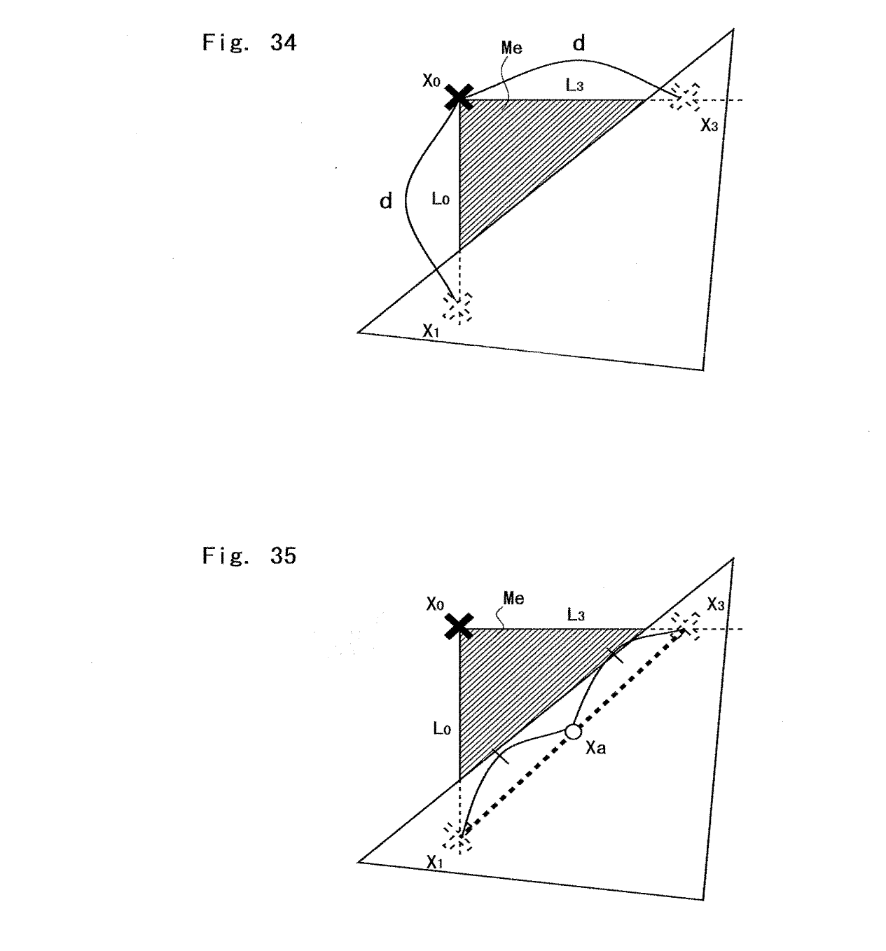

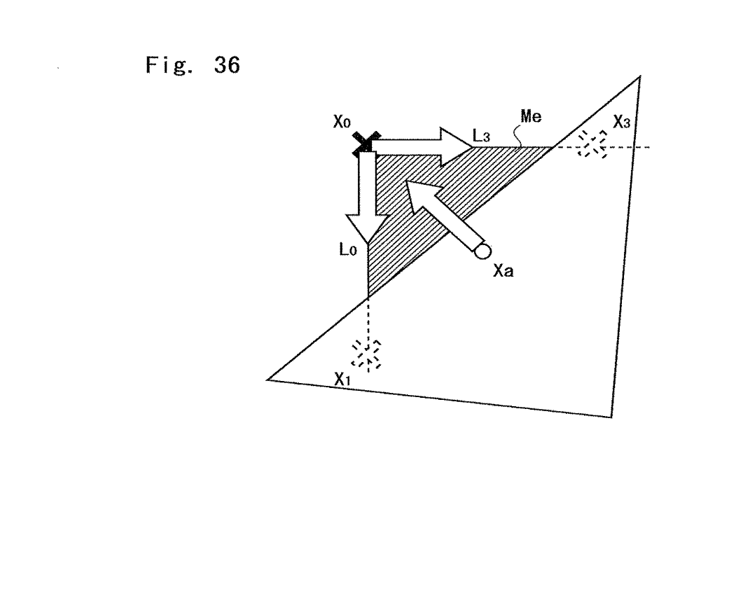

Further, as shown in FIG. 34, the plane estimation unit 33 estimates the three-dimensional coordinates of the two feature points X1 and X3 adjacent to the feature point X0 that could have been recognized in the marker area Me projected onto the projection plane. At this time, the plane estimation unit 33 estimates the three-dimensional coordinates of the two feature points X1 and X3 that are hidden using the shape information of the marker (whether the marker is a square and the length of each side). That is, the plane estimation unit 33 estimates the points that are located on the lines obtained by extending the sides L0 and L3 extending from the feature point X0 that could have been recognized and are spaced apart from the feature point X0 that could have been recognized by a distance d, which is the length of the side that has been acquired in advance, as the two feature points X1 and X3 that are hidden.

The plane estimation unit 33 estimates the three-dimensional coordinates of the midpoint Xa of the line segment (diagonal line of the marker) that connects the two estimated feature points X1 and X3 as the coordinates that indicate the position of the marker.

Next, the plane estimation unit 33 estimates the vector of the side L3 extending from the feature point X0 that has been recognized to the estimated feature point X3 as the vector in the x-axis direction. Further, the plane estimation unit 33 estimates the vector of the side L1 extending from the feature point X0 that has been recognized to the estimated feature point X1 as the vector in the y-axis direction. Further, the plane estimation unit 33 estimates the normal vector of the estimated plane as the vector in the z-axis direction. According to this operation, the plane estimation unit 33 estimates the marker coordinate system (posture of the marker).

As described above, according to the configuration of the posture estimation device in this embodiment, even when the feature point of the marker is hidden in the camera image, the plane estimation unit 33 extends the sides of the marker toward the feature point that is hidden. The plane estimation unit 33 then estimates the intersection of the side that has been extended and the line segment obtained by extending another side of the marker as the feature point of the marker. Alternatively, the plane estimation unit 33 estimates the point that is located on the sides that have been extended and is spaced apart from the feature point that could have been recognized by the length of the side of the marker that has been acquired in advance as the feature point of the marker. Accordingly, even when the marker recognition unit 32 cannot recognize all four of the feature points of the marker in the camera image, the plane estimation unit 33 is able to estimate the position and the posture of the marker.

### Other Embodiments

Other embodiments of the present invention will be described. In the above embodiments, an example in which the individual is identified by recognizing the marker attached to the subject surface and reading out the ID has been described. However, the present invention is not limited to this example.

For example, the posture estimation device 30 may store in advance template images having different figures for each individual which is to be estimated to perform template matching on the camera image using the template images. The individual which is to be estimated can also be recognized using this method as well.

Further, the specification and the selection of the subject surface which is to be estimated (a predetermined area in the camera image) are not necessarily performed automatically using markers or figures or the like. For example, the subject surface which is to be estimated may be selected from among the subjects in the camera image by a user using a manipulation key, a touch panel or the like. Further, the subject surface in a predetermined area in the camera image (an area fixed in advance such as a central area, an upper right area, a lower left area of the angle of view of the camera) may be specified as the target to be estimated.

Further, while the image processing system including the posture estimation device has been described in the above embodiments, this whole system may be applied to the robot.

For example, the above image processing system can be applied to a robot which is required to detect a predetermined object from the ambient environment. Specifically, the robot includes a camera, a three-dimensional sensor, and a posture estimation device. Since the robot that moves according to the ambient environment typically includes a camera and a three-dimensional sensor in order to grasp the status of the ambient environment, these devices may be used.

The robot generates a camera image using the camera. The robot further generates a distance image using the three-dimensional sensor. As described above, the posture estimation device acquires the subject distance information from the distance image to acquire the three-dimensional coordinates of the plurality of pixels in the marker area.

At this time, the robot may not necessarily generate the distance image. For example, the robot may separately detect the distances to the plurality of subjects of the plurality of pixels using a simple distance sensor or the like. It is therefore possible to acquire the plurality of subject distances of the plurality of pixels without generating the distance image.

Note that the present invention is not limited to the above embodiments and may be changed or combined as needed without departing from the spirit of the present invention.

This application is based upon and claims the benefit of priority from Japanese Patent Application No. 2013-189660, filed on Sep. 12, 2013, the disclosure of which is incorporated herein in its entirety by reference.

### INDUSTRIAL APPLICABILITY

The technique according to the present invention is applicable to a posture estimation method, a robot and the like.

### REFERENCE SIGNS LIST

10 CAMERA
20 THREE-DIMENSIONAL SENSOR
30 POSTURE ESTIMATION DEVICE
31 CONTROLLER
32 MARKER RECOGNITION UNIT
33 PLANE ESTIMATION UNIT
34 ACCURACY EVALUATION UNIT

1: A posture estimation method comprising:
acquiring a captured image generated by capturing a subject using an imaging apparatus;
acquiring a plurality of coordinates corresponding to a plurality of pixels included in a predetermined area in the captured image;
acquiring subject distance information indicating a distance from the subject to the imaging apparatus in the plurality of pixels; and
estimating a posture of the subject surface included in the subject in the predetermined area based on the plurality of pieces of subject distance information and the plurality of coordinates that have been acquired.

2: The posture estimation method according to claim 1, comprising:
acquiring a distance image where each pixel includes the subject distance information;
associating the pixels in the captured image with the pixels in the distance image; and
acquiring the subject distance information from pixels corresponding to the plurality of pixels in the predetermined area of the pixels in the distance image.

3: The posture estimation method according to claim 1, comprising:
calculating three-dimensional coordinates of the plurality of pixels based on the subject distance information and coordinates of the plurality of pixels; and
estimating the posture of the subject surface included in the predetermined area based on the three-dimensional coordinates of the plurality of pixels.

4: The posture estimation method according to claim 1, wherein
a marker is attached to the subject surface, and
the posture estimation method further comprises:
detecting a marker area including the marker in the captured image as the predetermined area; and
estimating the posture of the marker included in the marker area that has been detected.

5: The posture estimation method according to claim 4, comprising:
calculating an equation of a projection plane that is parallel to the subject surface using the subject distance information and the coordinates of the plurality of pixels;
projecting a feature point indicating the posture of the marker in the captured image onto the projection plane; and
estimating the posture of the marker based on the coordinates of the feature point projected onto the projection plane.

6: The posture estimation method according to claim 5,
comprising specifying the coordinates of the feature point in the captured image with sub-pixel precision to project the feature point onto the projection plane using the coordinates of the feature point that have been specified.

7: The posture estimation method according to claim 5, comprising:
estimating the position of the marker based on the coordinates of the feature point projected onto the projection plane;
calculating the coordinates of the feature point on the projection plane using information regarding the estimated posture of the marker, the estimated position of the marker, and the size of the marker that has been set in advance;
projecting the feature point that has been calculated on the projection plane onto the captured image;
comparing, in the captured image, the coordinates of the feature point when the subject is captured with the coordinates of the feature point that have been projected; and
determining an estimation accuracy based on the comparison result.

8: The posture estimation method according to claim 5, comprising:
estimating the position of the marker based on the coordinates of the feature point projected onto the projection plane;
calculating the coordinates of the feature point on the projection plane using information regarding the estimated posture of the marker, the estimated position of the marker, and the size of the marker that has been set in advance;
comparing the coordinates of the feature point projected from the captured image when the posture of the marker is estimated with the coordinates of the feature point that have been calculated on the projection plane; and
determining an estimation accuracy based on the comparison result.

9: The posture estimation method according to claim 5, wherein
the marker has a substantially rectangular shape, and
the posture estimation method further comprises:
detecting the apices of the marker in the captured image as the feature points;
extending sides of the marker extending from the feature points that have been detected when the number of feature points that have been detected is two or three; and
estimating the intersection of the sides that have been extended as the feature point.

10: The posture estimation method according to claim 5, wherein
the marker has a substantially rectangular shape, and
the posture estimation method further comprises:
detecting the apices of the marker in the captured image as the feature points;
extending sides of the marker extending from the feature points that have been detected when the number of feature points that have been detected is four or less; and
estimating a point that is located on the sides that have been extended and is spaced apart from the feature points that have been detected by a predetermined distance as the feature point.

11: A robot comprising:
the imaging apparatus;
a distance sensor that acquires the subject distance information; and
a posture estimation device that executes the posture estimation method according to claim 1.
